(19) United States
(12) Patent Application Publication
(10) Pub. No.: US 2026/0282033 A1
(43) Pub. Date: Sep. 17, 2026

(54) METHOD AND APPARATUS FOR MULTI-CELL SCHEDULING ENHANCEMENT

(71) Applicant: LENOVO (BEIJING) LIMITED, Beijing (CN)

(72) Inventor: Haipeng LEI, Beijing (CN)

(21) Appl. No.: 19/472,544

(22) PCT Filed: Apr. 11, 2023
(86) PCT No.: PCT/CN2023/087621

§ 371 Date: Oct. 3, 2025

(51) Int. Cl. H04W 72/232; H04L 5/00; H04W 72/1263

(52) U.S. Cl. CPC H04W 72/232; H04L 5/0091; H04W 72/1263

(57) ABSTRACT

Embodiments of the present disclosure relate to methods and apparatuses for multi-cell scheduling enhancement in the CA scenario. According to some embodiments of the disclosure, a UE may: receive, from a BS, a first DCI format including information for decoding a second DCI format; decode the second DCI format based on the information for decoding the second DCI format; and based on the first DCI format, the second DCI format or both, receive downlink data channel(s) from the BS on one or more cells among a plurality of cells configured for the UE by the BS when the first DCI format or the second DCI format schedules downlink transmission, or transmit uplink data channel(s) to the BS on one or more cells among the plurality of cells when the first DCI format or the second DCI format schedules uplink transmission.

### TECHNICAL FIELD

Embodiments of the present disclosure generally relate to wireless communication technology, and more particularly to multi-cell scheduling in the carrier aggregation (CA) scenario.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long-term evolution (LTE) systems, LTE-advanced (LTE-A) systems, or LTE-A Pro systems, and fifth generation (5G) systems, which may also be referred to as new radio (NR) systems.

In a wireless communication system, a base station (BS) and a user equipment (UE) may communicate via downlink (DL) channels and uplink (UL) channels. For example, a UE may monitor a physical downlink control channel (PDCCH) in one or more search spaces. The PDCCH may carry downlink control information (DCI), which may schedule uplink channels, such as a physical uplink shared channel (PUSCH), or downlink channels, such as a physical downlink shared channel (PDSCH).

Carrier aggregation (CA) technology may be used in a wireless communication system to, for example, increase data rates. For example, CA technology may refer to aggregating spectrum resources (e.g., carriers or cells) from the same frequency band or different frequency bands. In a CA scenario, multiple cells may be configured for a UE and DL or UL channels may be carried on one or more of the multiple cells.

There is a need for handling the multi-cell scheduling in the CA scenario.

### SUMMARY

Some embodiments of the present disclosure provide a user equipment (UE). The UE may include a transceiver, and a processor coupled to the transceiver. The processor may be configured to: receive, from a BS, a first downlink control information (DCI) format including information for decoding a second DCI format; decode the second DCI format based on the information for decoding the second DCI format; and based on the first DCI format, the second DCI format or both, receive downlink data channel(s) from the BS on one or more cells among a plurality of cells configured for the UE by the BS when the first DCI format or the second DCI format schedules downlink transmission, or transmit uplink data channel(s) to the BS on one or more cells among the plurality of cells when the first DCI format or the second DCI format schedules uplink transmission.

In some embodiments of the present disclosure, the first DCI format may further include information for scheduling a first cell of the one or more cells. In some embodiments of the present disclosure, receiving the downlink data channel(s) may include receiving a downlink data channel on the first cell based on the information for scheduling the first cell. In some embodiments of the present disclosure, transmitting the uplink data channel(s) may include transmitting an uplink data channel on the first cell based on the information for scheduling the first cell.

In some embodiments of the present disclosure, the processor may be further configured to determine a presence of the second DCI format based on the first DCI format.

In some embodiments of the present disclosure, decoding the second DCI format may include decoding the second DCI format when the second DCI format is determined to be present. In some embodiments of the present disclosure, receiving the downlink data channel(s) may include when the second DCI format is determined to be present, receiving a downlink data channel on a second cell of the one or more cells based on the second DCI format. In some embodiments of the present disclosure, wherein transmitting the uplink data channel(s) may include when the second DCI format is determined to be present, transmitting an uplink data channel on a second cell of the one or more cells based on the second DCI format.

In some embodiments of the present disclosure, the second DCI format is determined to be present when: the first DCI format indicates the one or more cells scheduled by the first and second DCI formats and the one or more cells include more than one cell; the first DCI format indicates the number of the one or more cells which is greater than one; the first DCI format indicates an applicable time domain offset between the first DCI format and the second DCI format; the first DCI format indicates an applicable resource for the second DCI format; an indicator in the first DCI format indicates that the second DCI format is present; the first DCI format indicates the one or more cells scheduled by the first and second DCI formats and a cell(s) scheduled by the first DCI format, the difference of which may include at least one cell; the first DCI format indicates a cell(s) scheduled by the second DCI format which may include at least one cell; or the first DCI format indicates the number of cells scheduled by the second DCI format which is greater than or equal to one.

In some embodiments of the present disclosure, the second DCI format may be received on a predefined cell of the plurality of cells. In some embodiments of the present disclosure, the second DCI format may be received on a predefined cell of the one or more cells. In some embodiments of the present disclosure, the second DCI format may be received on a cell where the first DCI format is received. In some embodiments of the present disclosure, the first DCI format may indicate a cell where the second DCI format is transmitted.

In some embodiments of the present disclosure, the first DCI format may further include common scheduling information for the one or more cells and cell-specific information for scheduling at least one cell of the one or more cells, and the second DCI format may include cell-specific information for scheduling the remaining cell(s) of the one or more cells.

In some embodiments of the present disclosure, the second DCI format may include scheduling information for the one or more cells. In some embodiments of the present disclosure, wherein the first DCI format may further include common scheduling information for the one or more cells and the second DCI format may include cell-specific information for scheduling the one or more cells.

In some embodiments of the present disclosure, the cell-specific information for scheduling a corresponding cell may indicate one or more of: a time domain resource assignment for the corresponding cell, a frequency domain resource assignment for the corresponding cell, a modulation and coding scheme (MCS) for the corresponding cell, a hybrid automatic repeat request (HARQ) process number for the corresponding cell, a new data indicator for the corresponding cell, and a redundancy version for the corresponding cell.

In some embodiments of the present disclosure, the common scheduling information for the one or more cells may indicate one or more of: virtual resource block (VRB) to physical resource block (PRB) mapping information for the one or more cells, a PRB bundling size for the one or more cells, and physical uplink control channel (PUCCH) related information for the one or more cells.

In some embodiments of the present disclosure, the information for decoding the second DCI format may indicate one or more of: a time domain offset between the first DCI format and the second DCI format, a resource for the second DCI format, the one or more cells among the plurality of cells, a payload size of the second DCI format, and a format of the second DCI format.

In some embodiments of the present disclosure, the processor may be further configured to determine the number of physical resource blocks (PRBs) carrying the second DCI format based on a payload size of the second DCI format and a coding rate for transmitting the second DCI format.

In some embodiments of the present disclosure, the processor may be further configured to receive, from the BS, radio resource control (RRC) signaling indicating a coding rate for transmitting the second DCI format. In some embodiments of the present disclosure, the first DCI format may indicate the coding rate.

Some embodiments of the present disclosure provide a BS. The BS may include a transceiver, and a processor coupled to the transceiver. The processor may be configured to: configure a plurality of cells for a UE; transmit, to the UE, a first DCI format including information for the UE to decode a second DCI format; transmit, to the UE, the second DCI format; and transmit downlink data channel(s) to the UE on one or more cells among the plurality of cells when the first DCI format or the second DCI format schedules downlink transmission, or receive uplink data channel(s) from the UE on one or more cells among the plurality of cells when the first DCI format or the second DCI format schedules uplink transmission.

In some embodiments of the present disclosure, the first DCI format may further include information for scheduling a first cell of the one or more cells. In some embodiments of the present disclosure, transmitting the downlink data channel(s) may include transmitting a downlink data channel on the first cell based on the information for scheduling the first cell. In some embodiments of the present disclosure, receiving the uplink data channel(s) may include receiving an uplink data channel on the first cell based on the information for scheduling the first cell.

In some embodiments of the present disclosure, the processor may be further configured to determine a presence of the second DCI format based on the first DCI format.

In some embodiments of the present disclosure, transmitting the second DCI format may include transmitting the second DCI format when the second DCI format is determined to be present. In some embodiments of the present disclosure, transmitting the downlink data channel(s) may include when the second DCI format is determined to be present, transmitting a downlink data channel on a second cell of the one or more cells based on the second DCI format. In some embodiments of the present disclosure, receiving the uplink data channel(s) may include when the second DCI format is determined to be present, receiving an uplink data channel on a second cell of the one or more cells based on the second DCI format.

In some embodiments of the present disclosure, the second DCI format is determined to be present when: the first DCI format indicates the one or more cells scheduled by the first and second DCI formats and the one or more cells include more than one cell; the first DCI format indicates the number of the one or more cells which is greater than one; the first DCI format indicates an applicable time domain offset between the first DCI format and the second DCI format; the first DCI format indicates an applicable resource for the second DCI format; an indicator in the first DCI format indicates that the second DCI format is present; the first DCI format indicates the one or more cells scheduled by the first and second DCI formats and a cell(s) scheduled by the first DCI format, the difference of which may include at least one cell; the first DCI format indicates a cell(s) scheduled by the second DCI format which may include at least one cell; or the first DCI format indicates the number of cells scheduled by the second DCI format which is greater than or equal to one.

In some embodiments of the present disclosure, the second DCI format may be transmitted on a predefined cell of the plurality of cells. In some embodiments of the present disclosure, the second DCI format may be transmitted on a predefined cell of the one or more cells. In some embodiments of the present disclosure, the second DCI format may be transmitted on a cell where the first DCI format is received. In some embodiments of the present disclosure, the first DCI format may indicate a cell where the second DCI format is transmitted.

In some embodiments of the present disclosure, the first DCI format may further include common scheduling information for the one or more cells and cell-specific information for scheduling at least one cell of the one or more cells, and the second DCI format may include cell-specific information for scheduling the remaining cell(s) of the one or more cells.

In some embodiments of the present disclosure, the second DCI format may include scheduling information for the one or more cells. In some embodiments of the present disclosure, the first DCI format may further include common scheduling information for the one or more cells and the second DCI format may include cell-specific information for scheduling the one or more cells.

In some embodiments of the present disclosure, the cell-specific information may indicate one or more of: a time domain resource assignment for a corresponding cell, a frequency domain resource assignment for the corresponding cell, a modulation and coding scheme (MCS) for the corresponding cell, a hybrid automatic repeat request (HARQ) process number for the corresponding cell, a new data indicator for the corresponding cell, and a redundancy version for the corresponding cell.

In some embodiments of the present disclosure, the common scheduling information for the one or more cells may indicate one or more of: virtual resource block (VRB) to physical resource block (PRB) mapping information for the one or more cells, a PRB bundling size for the one or more cells, and physical uplink control channel (PUCCH) related information for the one or more cells.

In some embodiments of the present disclosure, the information for decoding the second DCI format may indicate one or more of: a time domain offset between the first DCI format and the second DCI format, a resource for the second DCI format, the one or more cells among the plurality of cells, a payload size of the second DCI format, and a format of the second DCI format.

In some embodiments of the present disclosure, the processor may be further configured to determine the number of physical resource blocks (PRBs) for transmitting the second DCI format based on a payload size of the second DCI format and a coding rate for transmitting the second DCI format.

In some embodiments of the present disclosure, the processor may be further configured to transmit, to the UE, radio resource control (RRC) signaling indicating a coding rate for transmitting the second DCI format. In some embodiments of the present disclosure, the first DCI format may indicate the coding rate.

Some embodiments of the present disclosure provide a method performed by a UE. The method may include: receiving, from a BS, a first DCI format including information for decoding a second DCI format; decoding the second DCI format based on the information for decoding the second DCI format; and based on the first DCI format, the second DCI format or both, receiving downlink data channel(s) from the BS on one or more cells among a plurality of cells configured for the UE by the BS when the first DCI format or the second DCI format schedules downlink transmission, or transmitting uplink data channel(s) to the BS on one or more cells among the plurality of cells when the first DCI format or the second DCI format schedules uplink transmission.

Some embodiments of the present disclosure provide a method performed by a BS. The method may include: configuring a plurality of cells for a UE; transmitting, to the UE, a first DCI format including information for the UE to decode a second DCI format; transmitting, to the UE, the second DCI format; and transmitting downlink data channel(s) to the UE on one or more cells among the plurality of cells when the first DCI format or the second DCI format schedules downlink transmission, or receiving uplink data channel(s) from the UE on one or more cells among the plurality of cells when the first DCI format or the second DCI format schedules uplink transmission.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a schematic diagram of a DCI format scheduling a plurality of transmissions in accordance with some embodiments of the present disclosure;

FIGS. 3-5 illustrate schematic diagrams of two-stage DCIs scheduling a plurality of transmissions in accordance with some embodiments of the present disclosure;

FIG. 6 illustrates a schematic diagram of a first-stage DCI indicating the decoding information of a second-stage DCI in accordance with some embodiments of the present disclosure;

FIG. 7 illustrates an exemplary transmission procedure of a second-stage DCI format in accordance with some embodiments of the present disclosure;

FIG. 8 illustrates exemplary resource mapping of a second-stage DCI format in accordance with some embodiments of the present disclosure;

FIGS. 9 and 10 illustrate flow charts of an exemplary procedure of wireless communications in accordance with some embodiments of the present disclosure; and

FIG. 11 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

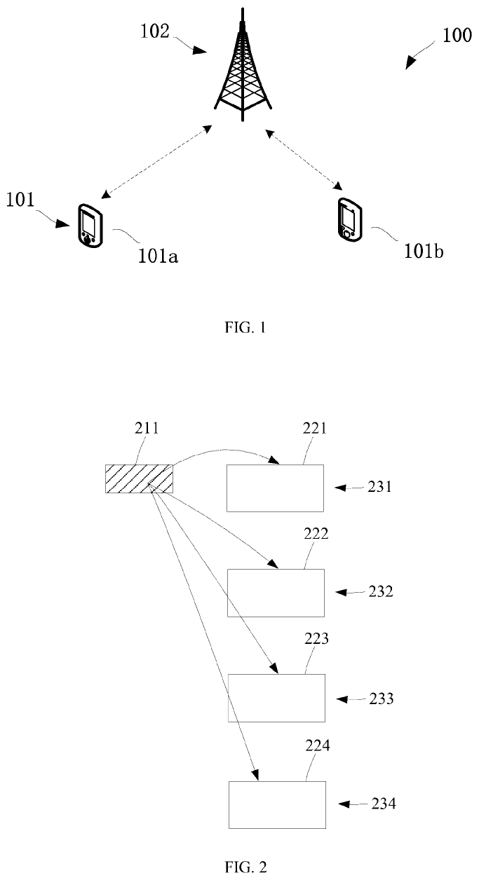

FIG. 1 illustrates a schematic diagram of wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographical region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high-altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

A communication system (e.g., NR) may be designed to support a maximum of 16 component carriers (CCs) in the case of CA or a maximum of 32 CCs in the case of dual connectivity (DC). In some embodiments of the present disclosure, in the case of CA, one DCI format can schedule at most one cell (e.g., carrier) by cross-cell (or cross-carrier) scheduling or self-scheduling. This requires much signaling overhead for PDCCHs to schedule DL transmissions (e.g., PDSCHs) or UL transmissions (e.g., PUSCHs) when, for example, the number of cells configured for a UE is large. To reduce signaling overhead, it would be beneficial to use a single DCI format to schedule multiple cells configured for the UE, which is referred to as multi-cell scheduling in the context of the present disclosure.

In some embodiments of the present disclosure, a single DCI can simultaneously schedule at most 4 cells by multi-cell scheduling. A dedicate DL DCI format (e.g., DCI format 1_3) may be introduced for joint scheduling up to 4 cells with each PDSCH per cell. A dedicate UL DCI format (e.g., DCI format 0_3) may be introduced for joint scheduling up to 4 cells with each PUSCH per cell.

For example, FIG. 2 illustrates a schematic diagram of a DCI format scheduling a plurality of transmissions in accordance with some embodiments of the present disclosure.

In some embodiments of the present disclosure, a plurality of CCs (e.g., including but not limited to CCs 231-234 in FIG. 2) may be configured for a UE. It should be understood that the sub-carrier spacings (SCSs) of the cells configured for a UE may be the same or different. Each of the plurality of CCs may correspond to a respective cell (e.g., serving cell) or carrier of the UE. Each cell (serving cell) may be associated with a (serving) cell index.

In some embodiments of the present disclosure, instead of using separate DCI formats to respectively schedule a plurality of transmissions on a plurality of cells, a BS may transmit a single DCI format to schedule the plurality of transmissions on the plurality of cells. For example, as shown in FIG. 2, DCI format 211 may schedule transmissions 221-224 on CCs 231-234, where each CC carries a single transmission.

In some examples, transmissions 221-224 may be uplink transmissions, for example, uplink physical data channels such as PUSCHs. In some examples, transmissions 221-224 may be downlink transmissions, for example, downlink physical data channels such as PDSCHs.

In FIG. 2, the cell (i.e., CC 231) on which DCI format 211 is detected carries one (e.g., transmission 221) of the scheduled transmissions. This may be referred to as self-scheduling. Other transmissions (e.g., transmissions 222-224) of the scheduled transmissions are scheduled on cells different from the one (i.e., CC 231) on which DCI format 211 is detected. This may be referred to as cross-cell (or cross-carrier) scheduling.

Although in FIG. 2, DCI format 211 schedules a plurality of transmissions via both self-scheduling and cross-cell scheduling, it should be understood that a DCI format may schedule a plurality of transmissions via only cross-cell scheduling. It also should be understood that a cell (e.g., a CC) scheduled by a DCI format may carry more than one transmission (e.g., PDSCHs or PUSCHs) in some other embodiments of the present disclosure.

Due to the limitation of the encoding method (e.g., Polar encoding), the maximum number of bits per DCI may be limited (e.g., 140 bits). With the increase of number of co-scheduled cells, a single DCI cannot accommodate too many bits especially when a maximum of 2 codewords per data channel (e.g., PDSCH) is configured.

Table 1 below shows an exemplary payload size of DCI format 1_3. In Table 1, it is assumed that each cell for multi-cell scheduling includes 275 physical resource blocks (PRBs). The definitions of the fields shown in Table 1 can be found in 3GPP specifications. It should be understood that Table 1 is only for illustrative purposes, and should not be construed as limiting the embodiments of the present disclosure.

TABLE 1
Payload size of DCI format 1_3

| | Single- | | | | |
|---|---|---|---|---|---|
| | cell | | 2-cell | 3-cell | 4-cell |
| | sched- | | sched- | sched- | sched- |
| Fields of DCI | uling | Field | uling | uling | uling |
| format 1_3 | (bits) | type | (bits) | (bits) | (bits) |
| Identifier for DCI | 1 | Type-1 | 1 | 1 | 1 |
| formats | | | | | |
| Indicator of | 3 | Type-1 | 3 | 3 | 3 |
| co-scheduled cells | | | | | |
| BWP indicator | 2 | Type-1 | 2 | 2 | 2 |
| FDRA (RA Type 0 | 18 | Type-2 | 36 | 54 | 72 |
| with RBG size 16) | | | | | |
| TDRA | 4 | Type-1 | 5 | 5 | 5 |
| VRB-to-PRB | 1 | Type-1 | 1 | 1 | 1 |
| mapping | | | | | |
| PRB bundling size | 1 | Type-1 | 1 | 1 | 1 |
| indicator | | | | | |
| Rate matching | 2 | Type-1 | 4 | 4 | 4 |
| indicator | | | | | |
| ZP CSI-RS trigger | 2 | Type-1 | 3 | 3 | 3 |
| MCS for TB1 | 5 | Type-2 | 10 | 15 | 20 |
| NDI for TB1 | 1 | Type-2 | 2 | 3 | 4 |
| RV for TB1 | 2 | Type-2 | 4 | 6 | 8 |
| MCS for TB2 (if | 5 | Type-2 | 10 | 15 | 20 |
| configured) | | | | | |
| NDI for TB2 (if | 1 | Type-2 | 2 | 3 | 4 |
| configured) | | | | | |
| RV for TB2 (if | 2 | Type-2 | 4 | 6 | 8 |
| configured) | | | | | |
| HARQ process | 4 | Type-2 | 8 | 12 | 16 |
| number | | | | | |
| DAI | 4 | Type-1 | 4 | 4 | 4 |
| TPC for scheduled | 2 | Type-1 | 2 | 2 | 2 |
| PUCCH | | | | | |
| PUCCH resource | 3 | Type-1 | 3 | 3 | 3 |
| indicator | | | | | |
| HARQ timing | 3 | Type-1 | 3 | 3 | 3 |
| indicator | | | | | |
| One-shot | 1 | Type-1 | 1 | 1 | 1 |
| HARQ-ACK request | | | | | |
| Antenna port(s) | 4 | Type-3 | 8 | 12 | 16 |
| TCI | 3 | Type-1B | 4 | 4 | 4 |
| SRS request | 2 | Type-1B | 4 | 4 | 4 |
| SRS offset indicator | 2 | Type-1B | 3 | 3 | 3 |
| DMRS sequence | 1 | Type-1A | 1 | 1 | 1 |
| initialization | | | | | |
| Priority indicator | 1 | Type-1 | 1 | 1 | 1 |
| ChannelAccess-CPext | 2 | Type-1 | 2 | 2 | 2 |
| Total size excluding | 72 | | 132 | 174 | 216 |
| CRC | | | | | |

In the example of Table 1, it is obvious that only 2 cells can be co-scheduled by a single DCI in the case of a maximum of 2 codewords per PDSCH configured per cell. In that sense, the DL peak data rate would be greatly reduced with the multi-cell scheduling mechanism. To fully exploit the spatial domain gain, a single DCI is expected to support, for example, the scheduling of up to 4 cells with one PDSCH/PUSCH per cell and each cell configured with a maximum of 2 codewords per cell, or up to 4 cells with multiple PDSCHs/PUSCHs per cell and each cell configured with a maximum of 2 codewords per cell, or up to 8 cells with one or multiple PDSCHs/PUSCHs per cell with or without a maximum of 2 codewords configured per cell.

To gain the end, one solution is to support a DCI format with a huge payload size, which is not supported or anticipated in the current communication technologies. Embodiments of the present disclosure propose a new scheduling mechanism for CA enhancement which can solve the above issues. For example, a two-stage DCI is proposed for the multi-cell scheduling DCI design. Embodiments of the present disclosure can not only alleviate the large DCI payload size, but also guarantee the existing PDCCH blind detection of a UE. More details on the embodiments of the present disclosure will be illustrated in the following text in combination with the appended drawings.

It should be noted that the solutions of the present disclosure can be applied to both downlink transmissions (e.g., downlink data channels such as PDSCHs) and uplink transmissions (e.g., uplink data channels such as PUSCHs) scheduled by a DCI format.

In some embodiments of the present disclosure, a BS may configure a set of cells or a plurality of cells (denoted as cell set #1) which can be used for multi-cell scheduling for a UE. For example, the BS may transmit a DCI format to the UE, and the DCI format may schedule one or more downlink data channels (e.g., PDSCHs) or uplink data channels (e.g., PUSCHs) on one or more cells of cell set #1. In some embodiments of the present disclosure, the DCI format may be a two-stage DCI format. For example, the first-stage DCI format may include information for decoding the second-stage DCI format based on which the UE can receive and decode the second-stage DCI format. The UE can receive or transmit the scheduled data channels on the scheduled one or more cells based on the DCI format (e.g., the first-stage DCI format, the second-stage DCI format or both).

It should be noted the terms “two-stage,” “first-stage,” and “second-stage” as used herein only intend to illustrate that a DCI format can be divided into two parts; and other terms that can express the similar meaning can also be used, e.g., “two-step”, “first-step” and “second-step”. Details regarding the two-stage DCI and the corresponding scheduling mechanism will be described in the following text.

For example, in some embodiments of the present disclosure, for a set of cells or a plurality of cells (e.g., cell set #1) configured for multi-cell scheduling, the scheduling information can be divided into two parts: a first-stage DCI format (denoted as DCI #A1) and a second-stage DCI format (denoted as DCI #A2). That is, DCI #A1 and DCI #A2 can be used to schedule one or more cells among cell set #1.

DCI #A1 can schedule a single cell (denoted as cell #A) among the one or more co-scheduled cells, and include cell-specific scheduling information for cell #A. DCI #A2 can schedule the remaining co-scheduled cell(s), and include cell-specific scheduling information for each of the remaining co-scheduled cell(s). DCI #A1 may also include common scheduling information for all the co-scheduled cells and decoding information for DCI #A2. In the case that only a single cell (e.g., cell #A) is scheduled, DCI #A2 may not present and DCI #A1 may include scheduling information for cell #A and not include decoding information for DCI #A2.

Various methods can be employed for determining cell #A among the one or more co-scheduled cells. For example, cell #A can be determined using a predefined rule. For example, cell #A may be the cell with the smallest or largest serving cell index among the co-scheduled cells.

DCI #A1 may be carried on a PDCCH and transmitted in a UE-specific search space. DCI formats for single cell scheduling, for example, DCI format 0_1 for UL scheduling or DCI format 1_1 for DL scheduling can be employed as DCI #A1. Since all the necessary information for decoding DCI #A2 is indicated by DCI #A1, the UE does not need to blind detect DCI #A2.

Various methods can be employed for determining the cell where DCI #A2 is transmitted (from the perspective of a BS) or received (from the perspective of a UE). For simplicity, the following embodiments are presented from the BS's point of view for illustration.

For example, in some embodiments, DCI #A2 may be transmitted on a predefined cell of cell set #1, for example, the cell with the highest or lowest cell index among cell set #1. In some embodiments, DCI #A2 may be transmitted on a predefined cell of the one or more co-scheduled cells, for example, the cell with highest or lowest cell index among the co-scheduled cells. In some embodiments, DCI #A2 may be transmitted on the cell where DCI #A1 is transmitted. In some embodiments, DCI #A1 may indicate the cell where DCI #A2 is transmitted. For example, DCI #A1 may include a carrier indicator for indicating the cell index of the cell where DCI #A2 is transmitted.

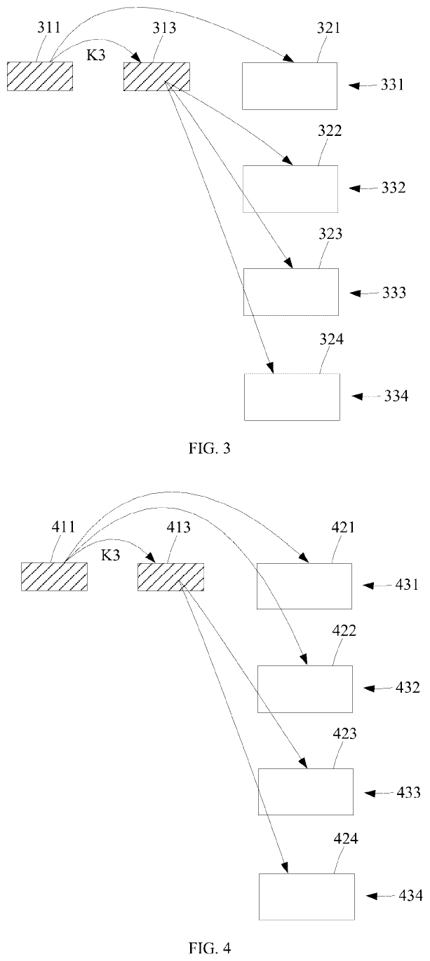

For example, referring to FIG. 3, a plurality of CCs (e.g., including but not limited to CCs 331-334 in FIG. 3) may be configured for a UE. It should be understood that the SCSs of the cells configured for a UE may be the same or different. Each of the plurality of CCs may correspond to a respective cell (e.g., serving cell) or carrier of the UE. Each cell (serving cell) may be associated with a (serving) cell index. For simplicity, it is assumed that the serving cell indices of CCs 331 to 334 are: CC 331<CC 332<CC 333<CC 334.

As shown in FIG. 3, a DCI format including first-stage DCI format 311 and second-stage DCI format 313 may schedule data channels (e.g., PDSCHs or PUSCHs) 321-324 on CCs 331-334, where each CC carries a single data channel. First-stage DCI format 311 may schedule data channel 321 on CC 331, which is the cell with the smallest serving cell index among the co-scheduled cells. Second-stage DCI format 313 may be transmitted on the cell where first-stage DCI format 311 is transmitted.

As mentioned above, the second-stage DCI format (e.g., DCI #A2) may or may not present. A UE which receives a first-stage DCI format (e.g., DCI #A1) may need to determine the presence of the corresponding second-stage DCI format (e.g., DCI #A2). The UE may decode the second-stage DCI format (e.g., DCI #A2) when the second-stage DCI format (e.g., DCI #A2) is determined to be present.

DCI #A1 may implicitly or explicitly indicate the presence of DCI #A2.

For example, in some embodiments, DCI #A1 may indicate the co-scheduled cells (e.g., all the cells co-scheduled by DCI #A1 and DCI #A2 among cell set #1). For example, DCI #A1 may include an indicator indicating all the co-scheduled cells, i.e., which cell(s) among cell set #1 are scheduled. When only a single cell is scheduled, it suggests that DCI #A2 is not present; otherwise, when more than one cell is scheduled, it suggests that DCI #A2 is present. Accordingly, the UE can determine the presence or absence of DCI #A2 based on the indicated co-scheduled cells.

For example, in some embodiments, DCI #A1 may indicate the number of co-scheduled cells. For example, DCI #A1 may include an indicator indicating the number of the co-scheduled cells. When only a single cell is scheduled, it suggests that DCI #A2 is not present; otherwise, when more than one cell (i.e., the number of the co-scheduled cells is greater than one) is scheduled, it suggests that DCI #A2 is present. Accordingly, the UE can determine the presence or absence of DCI #A2 based on the indicated number of co-scheduled cells. In some embodiments, the co-scheduled cells (i.e., which cell(s) among cell set #1 are scheduled) can be implicitly determined based on the frequency domain resource assignment (FDRA) field for each cell of cell set #1 in, for example, DCI #A2. For example, when an FDRA field corresponding to a cell in cell set #1 indicates an applicable value, this cell is scheduled; otherwise, when an FDRA field corresponding to a cell in cell set #1 indicates an inapplicable value, this cell is not scheduled. In some embodiments, an inapplicable value may be all 0s in the FDRA field for resource allocation Type 0 or all Is in the FDRA field for resource allocation Type 1, and an applicable value may be at least one 1 in the FDRA field for resource allocation Type 0 or at least one 1 in the FDRA field for resource allocation Type 1.

For example, in some embodiments, DCI #A1 may indicate a time domain offset (denoted as K3) between DCI #A1 and DCI #A2. For example, DCI #A1 may include an indicator indicating K3. When the indicator indicates an applicable time domain offset between DCI #A1 and DCI #A2, it suggests that DCI #A2 is present; otherwise, it suggests that DCI #A2 is not present. Accordingly, the UE can determine the presence or absence of DCI #A2 based on the indicator. For example, referring to FIG. 3, first-stage DCI format 311 may include an indicator indicating an applicable time domain offset (e.g., K3) between first-stage DCI format 311 and second-stage DCI format 313, which suggests that second-stage DCI format 313 is present. In some embodiments, an inapplicable time domain offset between DCI #A1 and DCI #A2 may be an offset value smaller than 0, and an applicable time domain offset between DCI #A1 and DCI #A2 may be an offset value larger than or equal to 0.

For example, in some embodiments, DCI #A1 may indicate a resource for DCI #A2. For example, DCI #A1 may include an indicator indicating the resource for DCI #A2. When the indicator indicates an applicable resource for DCI #A2, it suggests that DCI #A2 is present; otherwise, it suggests that DCI #A2 is not present. Accordingly, the UE can determine the presence or absence of DCI #A2 based on the indicator. In some embodiments, an inapplicable resource for DCI #A2 may be a resource without detailed time-frequency resource configuration, and an applicable resource for DCI #A2 may be a resource with detailed time-frequency resource configuration.

It should be noted that the above embodiments for implicitly determining the presence or absence of DCI #A2 are intended to be illustrative, not limiting. Various modifications may be made and other methods for implicitly determining the presence or absence of DCI #A2 can be employed without departing from the spirit and scope of the disclosure.

For example, in some embodiments, DCI #A1 may explicitly indicate whether DCI #A2 is present or not. For example, DCI #A1 may include an indicator indicating the presence or absence of DCI #A2. In some examples, this indicator can include one bit. For example, the bit value of “1” may indicate the presence of DCI #A2 while the bit value of “0” may indicate the absence of DCI #A2; or vice versa. The UE determines that DCI #A2 is present when the indicator indicates the presence of DCI #A2; otherwise, the UE determines that DCI #A2 is not present when the indicator indicates the absence of DCI #A2. Accordingly, the UE can determine the presence or absence of DCI #A2 based on the indicator.

In some embodiments of the present disclosure, when DCI #A1 (implicitly or explicitly) indicates the presence of DCI #A2, the concrete time-frequency resource of DCI #A2 is dynamically indicated by DCI #A1. Therefore, the UE does not need to blind detect the presence of DCI #A2. For example, as stated above, DCI #A1 may include information for decoding DCI #A2. In some embodiments, the information for decoding DCI #A2 may indicate a time domain offset between DCI #A1 and DCI #A2, a resource for DCI #A2, or both.

For example, in some embodiments, DCI #A1 may indicate a time domain offset (e.g., K3) between DCI #A1 (e.g., carried by a PDCCH) and DCI #A2. The time domain offset can be indicated in unit of slot, sub-slot, or other time units. For example, referring to FIG. 6, a first-stage DCI (e.g., DCI #A1) may be carried in a PDCCH and may indicate a time domain offset K3 between the PDCCH and the corresponding second-stage DCI (e.g., DCI #A2).

Various methods may be employed for indicating the value of K3. For example, DCI #A1 may include an indicator (denoted as indicator #A1) indicating the value of K3 from a set of offset values, for example, indicating one value from {0, 1, 2, 3, 4, 5, 6, 7}. The set of offset values can be configured by higher layer signaling (e.g., RRC signaling) or predefined, for example, in a standard(s). The size of indicator #A1 (e.g., the number of bits required) may be based on the number of values in the set of offset values. For example, the size of indicator #A1 may be equal to ┌ log₂ X1┐ bits, wherein X1 is the number of values in the set of offset values.

For example, in some embodiments, DCI #A1 may indicate a resource for DCI #A2. The resource can include time domain resource, frequency domain resource, code domain resource (e.g., orthogonal cover code or cyclic shift), or any combination thereof.

Various methods may be employed for indicating the resource for DCI #A2. For example, DCI #A1 may include an indicator (denoted as indicator #A2) indicating the resource for DCI #A2 from a set of resources. For example, each resource may correspond to a resource index and indicator #A2 may point to a resource index from a set of resource indexes, for example, {resource 0, resource 1, resource 2, resource 3, resource 4, resource 5, resource 6, resource 7}. Each resource of the set of resources can be configured by higher layer signaling (e.g., RRC signaling) or predefined, for example, in a standard(s). Each resource can be configured or predefined with one or more of the following parameters: a resource index, an index of the starting physical resource block (PRB) (e.g., the lowest PRB in the frequency domain), the number of PRBs, an index of the starting symbol (e.g., the earliest symbol in the time domain), the number of symbols, an orthogonal cover code length and an orthogonal cover code index. The size of indicator #A2 (e.g., the number of bits required) may be based on the number of values in the set of resources (e.g., the set of the resource indexes). For example, the size of indicator #A2 may be equal to ┌ log₂ Y1┐ bits, wherein Y1 is the number of values in the set of resources.

In some embodiments of the present disclosure, the number of actually used PRBs for transmitting or carrying DCI #A2 may be determined by the actual payload size of DCI #A2 and a coding rate for transmitting DCI #A2. In some embodiments, the coding rate for transmitting DCI #A2 may be configured for the UE by the BS via higher layer signaling (e.g., RRC signaling). The number of actually used PRBs is thus smaller when the actual payload size is smaller, keeping the effective code rate similar to the configured coding rate. In some embodiments, the coding rate may be indicated in DCI #A1 for dynamically adjusting the number of required PRBs for transmission of DCI #A2.

In some embodiments of the present disclosure, DCI #A2 may be typically transmitted at the end of a slot (or sub-slot). However, it is possible to transmit DCI #A2 in any other positions within a slot (or sub-slot). For example, referring to FIG. 6, a second-stage DCI (e.g., DCI #A2) may be transmitted at the end of a slot (e.g., occupying the last two symbols of the slot in the example of FIG. 6).

DCI #A2 may be modulated using various methods. For example, DCI #A2 may be modulated using quadrature phase shift keying (QPSK) and may be transmitted in a new waveform. The modulated symbols of DCI #A2 may be transmitted in the resource as indicated by DCI #A1, and may be mapped according to a predefine order, such as in an increasing order of frequency first and symbol next.

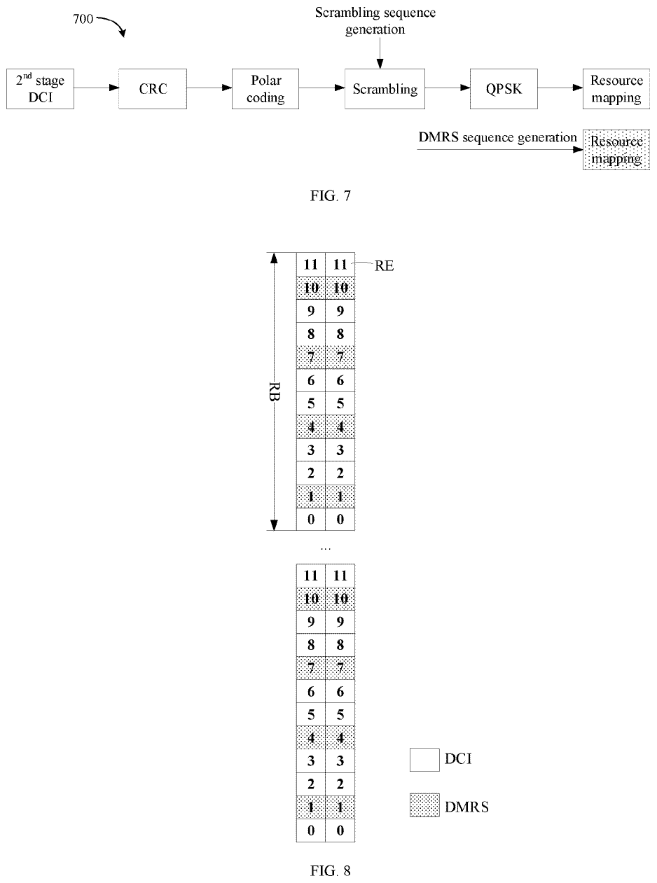

FIG. 7 shows exemplary transmission procedure 700 for a second-stage DCI format (e.g., DCI #A2). As shown in FIG. 7, firstly, a CRC is added to the second-stage DCI format (e.g., payload of the second-stage DCI format). Secondly, polar encoding is performed on the second-stage DCI format with CRC bits. Thirdly, scrambling is performed on the polar-encoded bits, wherein the scrambling sequence may be generated based on the cell radio network temporary identifier (C-RNTI) together with the physical layer cell identity or a configurable virtual cell identity, ensuring interference randomization across cells and devices using the same set of time-frequency resources, for example, cᵢₙᵢₜ=(n_{RNTI}·2¹⁶+n_{ID}) mod 2³¹, where n_{ID} is a higher-layer parameter if configured by RRC signaling, or equals to physical layer cell identity otherwise, and n_{RNTI} is given by the C-RNTI. Fourthly, a modulation such as QPSK modulation may be applied to the scrambled bits. Fifthly, resource mapping may be performed. For example, the QPSK modulated symbols may be mapped to subcarriers across multiple resource blocks using one or multiple consecutive OFDM symbols. Sixthly, a demodulation reference signal (DMRS) generation process and a corresponding resource mapping process may be performed. For example, a pseudo-random QPSK sequence, used as a DMRS to facilitate coherent reception at the UE side, may be uniformly mapped in each OFDM symbol and each PRB of the indicated resource for the second-stage DCI format. For example, FIG. 8 shows an exemplary frequency domain resource mapping after the above steps with one DMRS resource element (RE) every three subcarriers within one PRB, wherein the DCI can be the second-stage DCI format.

Persons skilled in the art can readily understand that a UE may perform a corresponding (e.g., inverse) procedure for receiving the second-stage DCI format.

As mentioned above, the first-stage DCI format (e.g., DCI #A1) may include common scheduling information for all the co-scheduled cells, specific scheduling information for the single cell (e.g., cell #A) scheduled by the first-stage DCI format, and information for decoding the second-stage DCI format (e.g., DCI #A2).

In some embodiments of the present disclosure, the common scheduling information for all the co-scheduled cells may indicate or include one or more of the following information for all the co-scheduled cells: VRB-to-PRB mapping information, a PRB bundling size indicator, and PUCCH related information. PUCCH related information may indicate or include one or more of the following: downlink assignment index (DAI), transmit power control (TPC), PUCCH resource indicator (PRI), and HARQ timing indicator.

It should be noted that in the context of the present disclosure, “common” scheduling information for all the co-scheduled cells does not necessarily mean that all the co-scheduled cells share the same scheduling information. For example, in some cases, common scheduling information may indicate separate information for each of co-scheduled cells via a joint indication. For example, in some embodiments, DCI #A1 may include a time domain resource assignment (TDRA) field for all the co-scheduled cells, the TDRA field may indicate a set of TDRAs, each of which may be associated with a corresponding cell of the co-scheduled cells and may be independent from each other.

In some embodiments of the present disclosure, specific scheduling information for the single cell (e.g., cell #A) may indicate or include one or more of the following for the single cell: a time domain resource assignment (TDRA) indication, a frequency domain resource assignment (FDRA) indication, MCS, a HARQ process number, a new data indicator (NDI), and a redundancy version (RV).

In some embodiments of the present disclosure, the information for decoding the second-stage DCI format (e.g., DCI #A2) may indicate or include one or more of the following: a time domain offset between the first-stage DCI format (e.g., DCI #A1) and the second-stage DCI format (e.g., DCI #A2), and the resource of the second-stage DCI format (e.g., DCI #A2). In some embodiments, the coding rate for transmitting the second-stage DCI format may be indicated in the first-stage DCI format for dynamically adjusting the number of required PRBs for transmission of the second-stage DCI format. That is, the information for decoding the second-stage DCI format in the first-stage DCI format may additionally include the coding rate.

It should be noted that in the case that the second-stage DCI format (e.g., DCI #A2) is absent (i.e., only a single cell is scheduled), the first-stage DCI format (e.g., DCI #A1) may only include scheduling information for the single cell and not include decoding information for the second-stage DCI format.

Table 2 below shows exemplary fields of a first-stage DCI format for DL scheduling. In Table 2, it is assumed that the single cell (e.g., cell #A and denoted as cell 1 in Table 2) scheduled by the first-stage DCI format includes 275 PRBs. The definitions of the fields shown in Table 2 can be found in 3GPP specifications.

TABLE 2
Fields of 1^{st}-stage DCI format

| DCI fields of 1^{st}-stage DCI | Size (bits) |
|---|---|
| Identifier for DCI formats | 1 |
| Indicator of co-scheduled cells | 3 |
| Bandwidth part indicator | 2 |
| Frequency domain resource assignment (cell 1) | 16 |
| Time domain resource assignment (cell 1) | 4 |
| VRB-to-PRB mapping | 1 |
| PRB bundling size indicator | 1 |
| Rate matching indicator | 2 |
| ZP CSI-RS trigger | 2 |
| TB1: Modulation and coding scheme (cell 1) | 5 |
| TB1: New data indicator (cell 1) | 1 |
| TB1: Redundancy version (cell 1) | 2 |
| TB2 (if configured): Modulation and coding | 5 |
| scheme (cell 1) | |
| TB2 (if configured): New data indicator (cell 1) | 1 |
| TB2 (if configured): Redundancy version (cell 1) | 2 |
| HARQ process number (cell 1) | 4 |
| Downlink assignment index | 4 |
| TPC command for scheduled PUCCH | 2 |
| PUCCH resource indicator | 3 |
| HARQ timing indicator | 3 |
| Antenna port(s) | 4 |
| Transmission configuration indication | 3 |
| SRS request | 2 |
| DMRS sequence initialization | 1 |
| K3 (i.e., time domain offset between 1^{st}-stage | 3 |
| DCI and 2^{nd}-stage DCI) | |
| Resource for 2^{nd}-stage DCI | 3 |
| CRC | 24 |

It should be understood that Table 2 is only for illustrative purposes, and should not be construed as limiting the embodiments of the present disclosure. For example, instead of indicating the “indicator of co-scheduled cells,” Table 2 may indicate the number of co-scheduled cells, and the specific co-scheduled cell can be determined based on the FDRA fields. It also should be noted that a field listed in Table 2 indicating “common” scheduling information for the co-scheduled cells may indicate separate information for each of co-scheduled cells via a joint indication.

As mentioned above, the second-stage DCI format (e.g., DCI #A2) may include cell-specific information for scheduling the remaining cell(s) of the one or more cells (e.g., all the co-scheduled cells except cell #A). For each of the remaining co-scheduled cell(s), the cell-specific scheduling information may indicate or include one or more of the following: a TDRA indication for the corresponding cell, an FDRA indication for the corresponding cell, an MCS for the corresponding cell, a HARQ process number for the corresponding cell, an NDI for the corresponding cell, and an RV for the corresponding cell. The items of the cell-specific information in the second-stage DCI format can be similar to those for the single cell (e.g., cell #A) in the first-stage DCI format (e.g., DCI #A1).

Table 3 below shows exemplary fields of a second-stage DCI format for DL scheduling. In Table 3, it is assumed that each of the remaining co-scheduled cells (denoted as cell 2 to cell M in Table 3, where M is the total number of the co-scheduled cells) scheduled by the 2^{nd}-stage DCI format includes 275 PRBs. The definitions of the fields shown in Table 3 can be found in 3GPP specifications.

TABLE 3
Fields of 2^{nd}-stage DCI

| DCI fields of 2^{nd}-stage DCI | Size (bits) |
|---|---|
| Frequency domain resource assignment (cell 2) | 16 |
| Time domain resource assignment (cell 2) | 4 |
| TB1: Modulation and coding scheme (cell 2) | 5 |
| TB1: New data indicator (cell 2) | 1 |
| TB1: Redundancy version (cell 2) | 2 |
| TB2 (if configured): Modulation and coding | 5 |
| scheme (cell 2) | |
| TB2 (if configured): New data indicator (cell 2) | 1 |
| TB2 (if configured): Redundancy version (cell 2) | 2 |
| HARQ process number (cell 2) | 4 |
| Frequency domain resource assignment (cell 3) | 16 |
| Time domain resource assignment (cell 3) | 4 |
| TB1: Modulation and coding scheme (cell 3) | 5 |
| TB1: New data indicator (cell 3) | 1 |
| TB1: Redundancy version (cell 3) | 2 |
| TB2 (if configured): Modulation and coding | 5 |
| scheme (cell 3) | |
| TB2 (if configured): New data indicator (cell 3) | 1 |
| TB2 (if configured): Redundancy version (cell 3) | 2 |
| HARQ process number (cell 3) | 4 |
| . . . | . . . |
| Frequency domain resource assignment (cell M) | 16 |
| Time domain resource assignment (cell M) | 4 |
| TB1: Modulation and coding scheme (cell M) | 5 |
| TB1: New data indicator (cell M) | 1 |
| TB1: Redundancy version (cell M) | 2 |
| TB2 (if configured): Modulation and coding | 5 |
| scheme (cell M) | |
| TB2 (if configured): New data indicator (cell M) | 1 |
| TB2 (if configured): Redundancy version (cell M) | 2 |
| HARQ process number (cell M) | 4 |
| CRC | 24 |

It should be understood that Table 3 is only for illustrative purposes, and should not be construed as limiting the embodiments of the present disclosure. For example, the second-stage DCI may only include cell-specific information fields. When some fields shown in Table 3 are set to common for all the co-scheduled cells (e.g., the same setting is shared among all the co-scheduled cells or the settings can be indicated via a joint indication), these fields can be removed from Table 3 and listed in, for example, Table 2. For example, when the TDRAs for all the co-scheduled cells are indicated via a joint indication, Table 2 may include a single TDRA field for all the co-scheduled cells and the TDRA fields in Table 3 may be removed.

For example, in some embodiments of the present disclosure, for a set of cells or a plurality of cells (e.g., cell set #1) configured for multi-cell scheduling, the scheduling information can be divided into two parts: a first-stage DCI format (denoted as DCI #B1) and a second-stage DCI format (denoted as DCI #B2). That is, DCI #B1 and DCI #B2 can be used to schedule one or more cells among cell set #1.

DCI #B1 can schedule at least one cell (e.g., including cell #B) among the one or more co-scheduled cells, and include cell-specific scheduling information for the at least one cell (also referred to as cell(s) directly scheduled by DCI #B1 or directly scheduled cell(s)). DCI #B2 can schedule the remaining co-scheduled cell(s), and include cell-specific scheduling information for each of the remaining co-scheduled cell(s). DCI #B1 may also include common scheduling information for all the co-scheduled cells and decoding information for DCI #B2. In certain cases, DCI #B2 may not present and DCI #B1 may include scheduling information for the directly scheduled cell(s) (e.g., cell #B) and not include decoding information for DCI #B2.

DCI #B1 may be carried on a PDCCH and transmitted in a UE-specific search space. DCI formats for multi-cell scheduling, for example, DCI format (e.g., DCI format 0_3) specified for UL multi-cell scheduling or DCI format (e.g., DCI format 1_3) specified for DL multi-cell scheduling can be employed as DCI #B1. Since all the necessary information for decoding DCI #B2 is indicated by DCI #B1, the UE does not need to blind detect DCI #B2.

Various methods can be employed for determining the cell where DCI #B2 is transmitted (from the perspective of a BS) or received (from the perspective of a UE). For simplicity, the following embodiments are presented from the BS's point of view for illustration.

For example, in some embodiments, DCI #B2 may be transmitted on a predefined cell of cell set #1, for example, the cell with the highest or lowest cell index among cell set #1. In some embodiments, DCI #B2 may be transmitted on a predefined cell of the one or more co-scheduled cells, for example, the cell with highest or lowest cell index among the co-scheduled cells. In some embodiments, DCI #B2 may be transmitted on the cell where DCI #B1 is transmitted. In some embodiments, DCI #B1 may indicate the cell where DCI #B2 is transmitted. For example, DCI #B1 may include a carrier indicator for indicating the cell index of the cell where DCI #B2 is transmitted.

For example, referring to FIG. 4, a plurality of CCs (e.g., including but not limited to CCs 431-434 in FIG. 4) may be configured for a UE. It should be understood that the SCSs of the cells configured for a UE may be the same or different. Each of the plurality of CCs may correspond to a respective cell (e.g., serving cell) or carrier of the UE. Each cell (serving cell) may be associated with a (serving) cell index.

As shown in FIG. 4, a DCI format including first-stage DCI format 411 and second-stage DCI format 413 may schedule data channels (e.g., PDSCHs or PUSCHs) 421-424 on CCs 431-434, where each CC carries a single data channel. First-stage DCI format 411 may schedule data channel 421 on CC 431 and data channel 422 on CC 432. Second-stage DCI format 413 may be transmitted on the cell where first-stage DCI format 411 is transmitted. K3 denotes the time domain offset between first-stage DCI format 411 and second-stage DCI format 413.

As mentioned above, the second-stage DCI format (e.g., DCI #B2) may or may not present. A UE which receives a first-stage DCI format (e.g., DCI #B1) may need to determine the presence of the corresponding second-stage DCI format (e.g., DCI #B2). The UE may decode the second-stage DCI format (e.g., DCI #B2) when the second-stage DCI format (e.g., DCI #B2) is determined to be present.

DCI #B1 may implicitly or explicitly indicate the presence of DCI #B2.

For example, in some embodiments, DCI #B1 may indicate the co-scheduled cells (e.g., all the cells co-scheduled by DCI #B1 and DCI #B2 among cell set #1) and the cell(s) scheduled by DCI #B1. For example, DCI #B1 may include an indicator (denoted as indicator 1) indicating all the co-scheduled cells, i.e., which cell(s) among cell set #1 are scheduled. DCI #B1 may include another indicator (denoted as indicator 2) indicating the cell(s) directly scheduled by DCI #B1. When the two indicators indicate the same cell(s) (i.e., the co-scheduled cells indicated by indicator 1 are the same as those indicated by indicator 2), it suggests that DCI #B2 is not present. Otherwise, when the difference between the two indicators includes at least one cell (i.e., the co-scheduled cells indicated by indicator 1 include more cells than those indicated by indicator 2), it suggests that DCI #B2 is present. Accordingly, the UE can determine the presence or absence of DCI #B2 based on the two indicators.

For example, in some embodiments, DCI #B1 may indicate the cell(s) scheduled by DCI #B2. When the cell(s) scheduled by DCI #B2 includes at least one cell, it suggests that DCI #B2 is present; otherwise, it suggests that DCI #B2 is not present. For example, DCI #B1 may include an indicator (denoted as indicator 2′) indicating the cell(s) scheduled by DCI #B2 (i.e., the remaining cells that are not scheduled by DCI #B1 among the co-scheduled cells). In some examples, DCI #B1 may also include an indicator (e.g., indicator 1) indicating all the co-scheduled cells, i.e., which cell(s) among cell set #1 are scheduled. In some examples, DCI #B1 may also include an indicator (e.g., indicator 2) indicating the cell(s) directly scheduled by DCI #B1. The UE can determine the presence or absence of DCI #B2 based on indicator 2′, i.e., whether indicator 2′ indicates at least one cell or not.

For example, in some embodiments, DCI #B1 may indicate the number of cells scheduled by DCI #B2. When the number of cells scheduled by DCI #B2 is greater than or equal to one, it suggests that DCI #B2 is present; otherwise, it suggests that DCI #B2 is not present. For example, DCI #B1 may include an indicator (denoted as indicator 3) indicating the number of cells scheduled by DCI #B2. The UE can determine the presence or absence of DCI #B2 based on indicator 3. In some examples, DCI #B1 may also include an indicator indicating the cell(s) directly scheduled by DCI #B1.

For example, in some embodiments, DCI #B1 may indicate a time domain offset (denoted as K3) between DCI #B1 and DCI #B2. For example, DCI #B1 may include an indicator indicating K3. When the indicator indicates an applicable time domain offset between DCI #B1 and DCI #B2, it suggests that DCI #B2 is present; otherwise, it suggests that DCI #B2 is not present. Accordingly, the UE can determine the presence or absence of DCI #B2 based on the indicator.

For example, referring to FIG. 4, first-stage DCI format 411 may include an indicator indicate an applicable time domain offset (e.g., K3) between first-stage DCI format 411 and second-stage DCI format 413, which suggests that second-stage DCI format 413 is present. The inapplicable time domain offset between first-stage DCI format 411 and second-stage DCI format 413 may be an offset value larger than or equal to 0.

For example, in some embodiments, DCI #B1 may indicate a resource for DCI #B2. For example, DCI #B1 may include an indicator indicating the resource for DCI #B2. When the indicator indicates an applicable resource for DCI #B2, it suggests that DCI #B2 is present; otherwise, it suggests that DCI #B2 is not present. Accordingly, the UE can determine the presence or absence of DCI #B2 based on the indicator.

It should be noted that the above embodiments for implicitly determining the presence or absence of DCI #B2 are intended to be illustrative, not limiting. Various modifications may be made and other methods for implicitly determining the presence or absence of DCI #B2 can be employed without departing from the spirit and scope of the disclosure.

For example, in some embodiments, DCI #B1 may explicitly indicate whether DCI #B2 is present or not. For example, DCI #B1 may include an indicator indicating the presence or absence of DCI #B2. In some examples, this indicator can include one bit. For example, the bit value of “1” may indicate the presence of DCI #B2 while the bit value of “0” may indicate the absence of DCI #B2; or vice versa. The UE determines that DCI #B2 is present when the indicator indicates the presence of DCI #B2; otherwise, the UE determines that DCI #B2 is not present when the indicator indicates the absence of DCI #B2. Accordingly, the UE can determine the presence or absence of DCI #B2 based on the indicator.

In some embodiments of the present disclosure, when DCI #B1 (implicitly or explicitly) indicates the presence of DCI #B2, the concrete time-frequency resource of DCI #B2 is dynamically indicated by DCI #B1. Therefore, the UE does not need to blind detect the presence of DCI #B2. For example, as stated above, DCI #B1 may include information for decoding DCI #B2. In some embodiments, the information for decoding DCI #B2 may indicate a time domain offset between DCI #B1 and DCI #B2, a resource for DCI #B2, or both.

For example, in some embodiments, DCI #B1 may indicate a time domain offset (e.g., K3) between DCI #B1 (e.g., carried by a PDCCH) and DCI #B2. The time domain offset can be indicated in unit of slot, sub-slot, or other time units. For example, referring to FIG. 6, a first-stage DCI (e.g., DCI #B1) may be carried in a PDCCH and may indicate a time domain offset K3 between the PDCCH and the corresponding second-stage DCI (e.g., DCI #B2).

Various methods may be employed for indicating the value of K3. For example, DCI #B1 may include an indicator (denoted as indicator #B1) indicating the value of K3 from a set of offset values, for example, indicating one value from {0, 1, 2, 3, 4, 5, 6, 7}. The set of offset values can be configured by higher layer signaling (e.g., RRC signaling) or predefined, for example, in a standard(s). The size of indicator #B1 (e.g., the number of bits required) may be based on the number of values in the set of offset values. For example, the size of indicator #B1 may be equal to ┌ log₂ X2┐ bits, wherein X2 is the number of values in the set of offset values.

For example, in some embodiments, DCI #B1 may indicate a resource for DCI #B2. The resource can include time domain resource, frequency domain resource, code domain resource (e.g., orthogonal cover code or cyclic shift), or any combination thereof.

Various methods may be employed for indicating the resource for DCI #B2. For example, DCI #B1 may include an indicator (denoted as indicator #B2) indicating the resource for DCI #B2 from a set of resources. For example, each resource may correspond to a resource index and indicator #B2 may point to a resource index from a set of resource indexes, for example, {resource 0, resource 1, resource 2, resource 3, resource 4, resource 5, resource 6, resource 7}. Each resource of the set of resources can be configured by higher layer signaling (e.g., RRC signaling) or predefined, for example, in a standard(s). Each resource can be configured or predefined with one or more of the following parameters: a resource index, an index of the starting PRB (e.g., the lowest PRB in the frequency domain), the number of PRBs, an index of the starting symbol (e.g., the earliest symbol in the time domain), the number of symbols, an orthogonal cover code length and an orthogonal cover code index. The size of indicator #B2 (e.g., the number of bits required) may be based on the number of values in the set of resources (e.g., the set of the resource indexes). For example, the size of indicator #B2 may be equal to ┌ log₂ Y2┐ bits, wherein Y2 is the number of values in the set of resources.

In some embodiments of the present disclosure, the number of actually used PRBs for transmitting or carrying DCI #B2 may be determined by the actual payload size of DCI #B2 and a coding rate for transmitting DCI #B2. In some embodiments, the coding rate for transmitting DCI #B2 may be configured for the UE by the BS via higher layer signaling (e.g., RRC signaling). The number of actually used PRBs is thus smaller when the actual payload size is smaller, keeping the effective code rate similar to the configured coding rate. In some embodiments, the coding rate may be indicated in DCI #B1 for dynamically adjusting the number of required PRBs for transmission of DCI #B2.

In some embodiments of the present disclosure, DCI #B2 may be typically transmitted at the end of a slot (or sub-slot). However, it is possible to transmit DCI #B2 in any other positions within a slot (or sub-slot). For example, referring to FIG. 6, a second-stage DCI (e.g., DCI #B2) may be transmitted at the end of a slot (e.g., occupying the last two symbols of the slot in the example of FIG. 6).

DCI #B2 may be modulated using various methods. For example, DCI #B2 may be modulated using QPSK and may be transmitted in a new waveform. The modulated symbols of DCI #B2 may be transmitted in the resource as indicated by DCI #B1, and may be mapped according to a predefine order, such as in an increasing order of frequency first and symbol next.

Transmission procedure 700 in FIG. 7 and the exemplary frequency domain resource mapping in FIG. 8 can also be applied to DCI #B2. For example, after the steps shown in FIG. 7, DCI #B2 and the DMRS for DCI #B2 can be mapped to resources as shown FIG. 8. Persons skilled in the art can readily understand that a UE may perform a corresponding (e.g., inverse) procedure for receiving DCI #B2.

As mentioned above, the first-stage DCI format (e.g., DCI #B1) may include common scheduling information for all the co-scheduled cells, specific scheduling information for the cell(s) scheduled by the first-stage DCI format (e.g., directly scheduled cell(s)), and information for decoding the second-stage DCI format (e.g., DCI #B2).

In some embodiments of the present disclosure, the common scheduling information for all the co-scheduled cells may indicate or include one or more of the following information for all the co-scheduled cells: VRB-to-PRB mapping information, a PRB bundling size indicator, and PUCCH related information. PUCCH related information may indicate or include one or more of the following: DAI, TPC, PRI, and HARQ timing indicator.

In some embodiments of the present disclosure, for each cell of the directly scheduled cell(s) (e.g., cell #B), the specific scheduling information may indicate or include one or more of the following: a TDRA indication for the corresponding cell, an FDRA indication for the corresponding cell, an MCS for the corresponding cell, a HARQ process number for the corresponding cell, an NDI for the corresponding cell, and an RV for the corresponding cell.

In some embodiments of the present disclosure, the information for decoding the second-stage DCI format (e.g., DCI #B2) may indicate or include one or more of the following: a time domain offset between the first-stage DCI format (e.g., DCI #B1) and the second-stage DCI format (e.g., DCI #B2), and the resource of the second-stage DCI format (e.g., DCI #B2). In some embodiments, the coding rate for transmitting the second-stage DCI format may be indicated in the first-stage DCI format for dynamically adjusting the number of required PRBs for transmission of the second-stage DCI format. That is, the information for decoding the second-stage DCI format in the first-stage DCI format may additionally include the coding rate.

It should be noted that in the case that the second-stage DCI format (e.g., DCI #B2) is absent (i.e., only a single cell is scheduled), the first-stage DCI format (e.g., DCI #B1) may only include scheduling information for the directly scheduled cell(s) and not include decoding information for the second-stage DCI format.

Table 4 below shows exemplary fields of a first-stage DCI format for DL scheduling. In Table 4, it is assumed that two cells (denoted as cell 1 and cell 2 in Table 4) are directly scheduled by the first-stage DCI format and each cell includes 275 PRBs. The definitions of the fields shown in Table 4 can be found in 3GPP specifications.

TABLE 4
Fields of 1^{st}-stage DCI format

| DCI fields of 1^{st}-stage DCI | Size (bits) |
|---|---|
| Identifier for DCI formats | 1 |
| Indicator of directly co-scheduled cells (e.g., | 3 |
| indicator 2) | |
| Indicator of all the co-scheduled cells (e.g., | 2 |
| indicator 1) or Indicator of remaining | |
| co-scheduled cells (e.g., indicator 2′) | |
| Bandwidth part indicator | 2 |
| Frequency domain resource assignment (cell 1) | 16 |
| Frequency domain resource assignment (cell 2) | 16 |
| Time domain resource assignment (cell 1) | 4 |
| Time domain resource assignment (cell 2) | 4 |
| VRB-to-PRB mapping | 1 |
| PRB bundling size indicator | 1 |
| Rate matching indicator | 2 |
| ZP CSI-RS trigger | 2 |
| TB1: Modulation and coding scheme (cell 1) | 5 |
| TB1: New data indicator (cell 1) | 1 |
| TB1: Redundancy version (cell 1) | 2 |
| TB2 (if configured): Modulation and coding | 5 |
| scheme (cell 1) | |
| TB2 (if configured): New data indicator (cell 1) | 1 |
| TB2 (if configured): Redundancy version (cell 1) | 2 |
| HARQ process number (cell 1) | 4 |
| TB1: Modulation and coding scheme (cell 2) | 5 |
| TB1: New data indicator (cell 2) | 1 |
| TB1: Redundancy version (cell 2) | 2 |
| TB2 (if configured): Modulation and coding | 5 |
| scheme (cell 2) | |
| TB2 (if configured): New data indicator (cell 2) | 1 |
| TB2 (if configured): Redundancy version (cell 2) | 2 |
| HARQ process number (cell 2) | 4 |
| Downlink assignment index | 4 |
| TPC command for scheduled PUCCH | 2 |
| PUCCH resource indicator | 3 |
| HARQ timing indicator | 3 |
| Antenna port(s) | 4 |
| Transmission configuration indication | 3 |
| SRS request | 2 |
| DMRS sequence initialization | 1 |
| K3 (i.e., time domain offset between 1^{st}-stage | 3 |
| DCI and 2^{nd}-stage DCI) | |
| Resource for 2^{nd}-stage DCI | 3 |
| CRC | 24 |

It should be understood that Table 4 is only for illustrative purposes, and should not be construed as limiting the embodiments of the present disclosure. It also should be noted that a field listed in Table 4 indicating “common” scheduling information for the co-scheduled cells may indicate separate information for each of co-scheduled cells via a joint indication.

As mentioned above, the second-stage DCI format (e.g., DCI #B2) may include cell-specific information for scheduling the remaining cell(s) of the co-scheduled cells (e.g., all the co-scheduled cells except the directly scheduled cell(s)). For each of the remaining co-scheduled cell(s), the cell-specific scheduling information may indicate or include one or more of the following: a TDRA indication for the corresponding cell, an FDRA indication for the corresponding cell, an MCS for the corresponding cell, a HARQ process number for the corresponding cell, an NDI for the corresponding cell, and an RV for the corresponding cell. The items of the cell-specific information in the second-stage DCI format can be similar to those for the directly scheduled cell(s) (e.g., cell #B) in the first-stage DCI format (e.g., DCI #B1).

Table 5 below shows exemplary fields of a second-stage DCI format for DL scheduling. In Table 5, it is assumed that each of the remaining co-scheduled cells (denoted as cell 3 to cell M in Table 5, where M is the total number of the co-scheduled cells) scheduled by the second-stage DCI format includes 275 PRBs. The definitions of the fields shown in Table 5 can be found in 3GPP specifications.

TABLE 5
Fields of 2^{nd}-stage DCI

| DCI fields of 2^{nd}-stage DCI | Size (bits) |
|---|---|
| Frequency domain resource assignment (cell 3) | 16 |
| Time domain resource assignment (cell 3) | 4 |
| TB1: Modulation and coding scheme (cell 3) | 5 |
| TB1: New data indicator (cell 3) | 1 |
| TB1: Redundancy version (cell 3) | 2 |
| TB2 (if configured): Modulation and coding | 5 |
| scheme (cell 3) | |
| TB2 (if configured): New data indicator (cell 3) | 1 |
| TB2 (if configured): Redundancy version (cell 3) | 2 |
| HARQ process number (cell 3) | 4 |
| . . . | . . . |
| Frequency domain resource assignment (cell M) | 16 |
| Time domain resource assignment (cell M) | 4 |
| TB1: Modulation and coding scheme (cell M) | 5 |
| TB1: New data indicator (cell M) | 1 |
| TB1: Redundancy version (cell M) | 2 |
| TB2 (if configured): Modulation and coding | 5 |
| scheme (cell M) | |
| TB2 (if configured): New data indicator (cell M) | 1 |
| TB2 (if configured): Redundancy version (cell M) | 2 |
| HARQ process number (cell M) | 4 |
| CRC | 24 |

It should be understood that Table 5 is only for illustrative purposes, and should not be construed as limiting the embodiments of the present disclosure. For example, the second-stage DCI may only include cell-specific information fields. When some fields shown in Table 5 are set to common for all the co-scheduled cells (e.g., the same setting is shared among all the co-scheduled cells or the settings can be indicated via a joint indication), these fields can be removed from Table 5 and listed in, for example, Table 4.

For example, in some embodiments of the present disclosure, for a set of cells or a plurality of cells (e.g., cell set #1) configured for multi-cell scheduling, the scheduling information can be divided into two parts: a first-stage DCI format (denoted as DCI #C1) and a second-stage DCI format (denoted as DCI #C2). That is, DCI #C1 and DCI #C2 can be used to schedule one or more cells among cell set #1.

DCI #C1 may not directly schedule any cell, and therefore DCI #C2 is always present. The step of determining the presence of DCI #C2 can be omitted or a UE may always determine that DCI #C2 is present. DCI #C1 may include decoding information for DCI #C2. In some examples, DCI #C2 may include scheduling information for the one or more cells. That is, DCI #C2 may include information scheduling information for all the co-scheduled cells. In some examples, DCI #C2 may include cell-specific information for scheduling the one or more cells. DCI #C1 may include both the decoding information for DCI #C2 and common scheduling information for the one or more cells.

DCI #C1 may be carried on a PDCCH and transmitted in a UE-specific search space. A DCI format specified only for indicating the decoding information of the second-stage DCI can be employed as DCI #C1. Since all the necessary information for decoding DCI #C2 is indicated by DCI #C1, the UE does not need to blind detect DCI #C2.

Various methods can be employed for determining the cell where DCI #C2 is transmitted (from the perspective of a BS) or received (from the perspective of a UE). For simplicity, the following embodiments are presented from the BS's point of view for illustration.

For example, in some embodiments, DCI #C2 may be transmitted on a predefined cell of cell set #1, for example, the cell with the highest or lowest cell index among cell set #1. In some embodiments, DCI #C2 may be transmitted on a predefined cell of the one or more co-scheduled cells, for example, the cell with highest or lowest cell index among the co-scheduled cells. In some embodiments, DCI #C2 may be transmitted on the cell where DCI #C1 is transmitted. In some embodiments, DCI #C1 may indicate the cell where DCI #C2 is transmitted. For example, DCI #C1 may include a carrier indicator for indicating the cell index of the cell where DCI #C2 is transmitted.

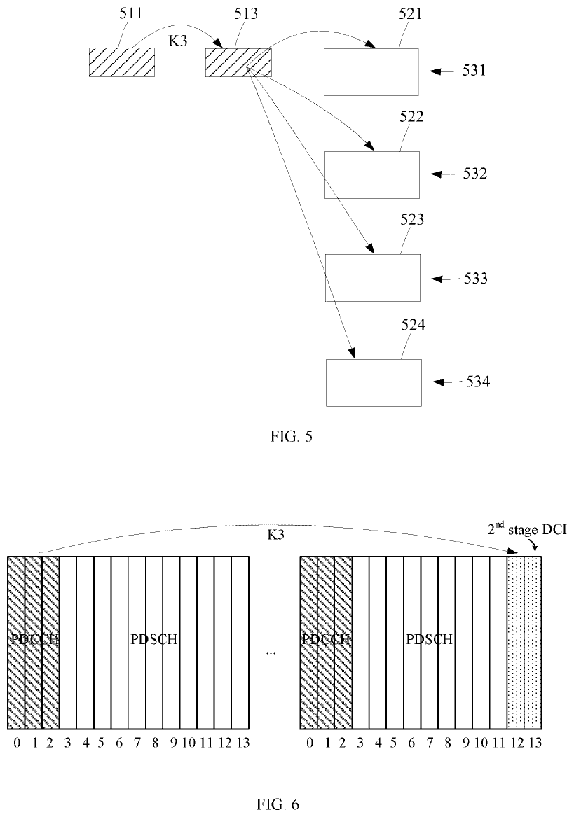

For example, referring to FIG. 5, a plurality of CCs (e.g., including but not limited to CCs 531-534 in FIG. 5) may be configured for a UE. It should be understood that the SCSs of the cells configured for a UE may be the same or different. Each of the plurality of CCs may correspond to a respective cell (e.g., serving cell) or carrier of the UE. Each cell (serving cell) may be associated with a (serving) cell index.

As shown in FIG. 5, a DCI format including first-stage DCI format 511 and second-stage DCI format 513 may schedule data channels (e.g., PDSCHs or PUSCHs) 521-524 on CCs 531-534, where each CC carries a single data channel. First-stage DCI format 511 may not schedule any data channel. Second-stage DCI format 513 may be transmitted on the cell where first-stage DCI format 511 is transmitted.

The concrete time-frequency resource of DCI #C2 is dynamically indicated by DCI #C1. The UE does not need to blind detect the presence of DCI #C2. For example, as stated above, DCI #C1 may include information for decoding DCI #C2. In some embodiments, the information for decoding DCI #C2 may indicate a time domain offset between DCI #C1 and DCI #C2, a resource for DCI #C2, the one or more scheduled cells among cell set #1, the payload size of DCI #C2, the format of DCI #C2, or any combination thereof.

For example, in some embodiments, DCI #C1 may indicate a time domain offset (e.g., K3) between DCI #C1 (e.g., carried by a PDCCH) and DCI #C2. The time domain offset can be indicated in unit of slot, sub-slot, or other time units. For example, referring to FIG. 6, a first-stage DCI (e.g., DCI #C1) may be carried in a PDCCH and may indicate a time domain offset K3 between the PDCCH and the corresponding second-stage DCI (e.g., DCI #C2).

Various methods may be employed for indicating the value of K3. For example, DCI #C1 may include an indicator (denoted as indicator #C1) indicating the value of K3 from a set of offset values, for example, indicating one value from {0, 1, 2, 3, 4, 5, 6, 7}. The set of offset values can be configured by higher layer signaling (e.g., RRC signaling) or predefined, for example, in a standard(s). The size of indicator #C1 (e.g., the number of bits required) may be based on the number of values in the set of offset values. For example, the size of indicator #C1 may be equal to ┌ log₂ X3┐ bits, wherein X3 is the number of values in the set of offset values.

For example, in some embodiments, DCI #C1 may indicate a resource for DCI #C2. The resource can include time domain resource, frequency domain resource, code domain resource (e.g., orthogonal cover code or cyclic shift), or any combination thereof.

Various methods may be employed for indicating the resource for DCI #C2. For example, DCI #C1 may include an indicator (denoted as indicator #C2) indicating the resource for DCI #C2 from a set of resources. For example, each resource may correspond to a resource index and indicator #C2 may point to a resource index from a set of resource indexes, for example, {resource 0, resource 1, resource 2, resource 3, resource 4, resource 5, resource 6, resource 7}. Each resource of the set of resources can be configured by higher layer signaling (e.g., RRC signaling) or predefined, for example, in a standard(s). Each resource can be configured or predefined with one or more of the following parameters: a resource index, an index of the starting PRB (e.g., the lowest PRB in the frequency domain), the number of PRBs, an index of the starting symbol (e.g., the earliest symbol in the time domain), the number of symbols, an orthogonal cover code length and an orthogonal cover code index. The size of indicator #C2 (e.g., the number of bits required) may be based on the number of values in the set of resources (e.g., the set of the resource indexes). For example, the size of indicator #C2 may be equal to ┌ log₂ Y3┐ bits, wherein Y3 is the number of values in the set of resources.

For example, in some embodiments, information for decoding DCI #C2 may include information for (implicitly or explicitly) determining the payload size of DCI #C2. For example, DCI #C1 may indicate all the co-scheduled cells among cell set #1. Such information can be used for determining the payload size of DCI #C2. For example, DCI #C1 may indicate the payload size of DCI #C2. In the case that the payload size of DCI #C2 is indicated by DCI #C1, the co-scheduled cells can be, (but not necessarily have to be) indicated by DCI #C2.

Various methods may be employed for indicating the payload size of DCI #C2. For example, DCI #C1 may include an indicator (denoted as indicator #C3) indicating the payload size of DCI #C2 from a set of possible payload sizes. The set of possible payload sizes can be configured by higher layer signaling (e.g., RRC signaling) or predefined, for example, in a standard(s). The size of indicator #C3 (e.g., the number of bits required) may be based on the number of values in the set of possible payload sizes. For example, the size of indicator #C3 may be equal to ┌ log₂ Z┐ bits, wherein Z is the number of values in the set of possible payload sizes. In some examples, DCI #C1 may include an indicator (denoted as indicator #C4) indicating the format of DCI #C2 from a set of possible formats. Each format of DCI #C2 is targeted for different scheduling cases, e.g., different number of co-scheduled cells, different maximum number of codewords for a cell. Each format of DCI #C2 includes multiple fields with each field having a predefined size. The payload size of DCI #C2 can be determined based on the indicated format of DCI #C2.

In some embodiments of the present disclosure, the number of actually used PRBs for transmitting or carrying DCI #C2 may be determined by the actual payload size of DCI #C2 and a coding rate for transmitting DCI #C2. In some embodiments, the coding rate for transmitting DCI #C2 may be configured for the UE by the BS via higher layer signaling (e.g., RRC signaling). The number of actually used PRBs is thus smaller when the actual payload size is smaller, keeping the effective code rate similar to the configured coding rate. In some embodiments, the coding rate may be indicated in DCI #C1 for dynamically adjusting the number of required PRBs for transmission of DCI #C2.

In some embodiments of the present disclosure, DCI #C2 may be typically transmitted at the end of a slot (or sub-slot). However, it is possible to transmit DCI #C2 in any other positions within a slot (or sub-slot). For example, referring to FIG. 6, a second-stage DCI (e.g., DCI #C2) may be transmitted at the end of a slot (e.g., occupying the last two symbols of the slot in the example of FIG. 6).

DCI #C2 may be modulated using various methods. For example, DCI #C2 may be modulated using QPSK and may be transmitted in a new waveform. The modulated symbols of DCI #C2 may be transmitted in the resource as indicated by DCI #C1, and may be mapped according to a predefine order, such as in an increasing order of frequency first and symbol next.

Transmission procedure 700 in FIG. 7 and the exemplary frequency domain resource mapping in FIG. 8 can also be applied to DCI #C2. For example, after the steps shown in FIG. 7, DCI #C2 and the DMRS for DCI #C2 can be mapped to resources as shown FIG. 8. Persons skilled in the art can readily understand that a UE may perform a corresponding (e.g., inverse) procedure for receiving DCI #C2.

As mentioned above, in some embodiments, the first-stage DCI format (e.g., DCI #C1) may only include information for decoding the second-stage DCI format (e.g., DCI #C2) and the second-stage DCI format (e.g., DCI #C2) may include all the information for scheduling all the co-scheduled cells. As stated above, the information for decoding the second-stage DCI format (e.g., DCI #C2) may indicate or include one or more of the following: a time domain offset between the first-stage DCI format (e.g., DCI #C1) and the second-stage DCI format (e.g., DCI #C2), and the resource of the second-stage DCI format (e.g., DCI #C2), the one or more scheduled cells among cell set #1, the payload size of the second-stage DCI format, and the format of the second-stage DCI format. In some embodiments, the coding rate for transmitting the second-stage DCI format may be indicated in the first-stage DCI format for dynamically adjusting the number of required PRBs for transmission of the second-stage DCI format. That is, the information for decoding the second-stage DCI format in the first-stage DCI format may additionally include the coding rate.

In some embodiments, the common scheduling information for all the co-scheduled cells may be included in the first-stage DCI format (e.g., DCI #C1). Thus, the second-stage DCI format (e.g., DCI #C2) may include specific scheduling information for the co-scheduled cells, instead of all the information for scheduling all the co-scheduled cells.

In some embodiments of the present disclosure, the common scheduling information may indicate or include one or more of the following information for all the co-scheduled cells: VRB-to-PRB mapping information, a PRB bundling size indicator, and PUCCH related information. PUCCH related information may indicate or include one or more of the following: DAI, TPC, PRI, and HARQ timing indicator.

In some embodiments of the present disclosure, for each of the co-scheduled cells, the specific scheduling information may indicate or include one or more of the following: a TDRA indication for the corresponding cell, an FDRA indication for the corresponding cell, an MCS for the corresponding cell, a HARQ process number for the corresponding cell, an NDI for the corresponding cell, and an RV for the corresponding cell.

Table 6 below shows exemplary fields of a first-stage DCI format for DL scheduling. The definitions of the fields shown in Table 6 can be found in 3GPP specifications.

TABLE 6
Fields of 1^{st}-stage DCI format

| DCI fields of 1^{st}-stage DCI | Size (bits) |
|---|---|
| Identifier for DCI formats | 1 |
| Indicator of co-scheduled cells | 3 |
| Bandwidth part indicator | 2 |
| VRB-to-PRB mapping | 1 |
| PRB bundling size indicator | 1 |
| Rate matching indicator | 2 |
| ZP CSI-RS trigger | 2 |
| Downlink assignment index | 4 |
| TPC command for scheduled PUCCH | 2 |
| PUCCH resource indicator | 3 |
| HARQ timing indicator | 3 |
| Antenna port(s) | 4 |
| Transmission configuration indication | 3 |
| SRS request | 2 |
| DMRS sequence initialization | 1 |
| K3 (i.e., time domain offset between 1^{st}-stage | 3 |
| DCI and 2^{nd}-stage DCI) | |
| Resource for 2^{nd}-stage DCI | 3 |
| CRC | 24 |

It should be understood that Table 6 is only for illustrative purposes, and should not be construed as limiting the embodiments of the present disclosure. It also should be noted that a field listed in Table 6 indicating “common” scheduling information for the co-scheduled cells may indicate separate information for each of co-scheduled cells via a joint indication.

Table 7 below shows exemplary fields of a second-stage DCI format for DL scheduling. In Table 7, it is assumed that each of the co-scheduled cells (denoted as cell 1 to cell M in Table 7, where M is the total number of the co-scheduled cells) includes 275 PRBs. The definitions of the fields shown in Table 7 can be found in 3GPP specifications.

TABLE 7
Fields of 2^{nd}-stage DCI

| DCI fields of 2^{nd}-stage DCI | Size (bits) |
|---|---|
| Frequency domain resource assignment (cell 1) | 16 |
| Time domain resource assignment (cell 1) | 4 |
| TB1: Modulation and coding scheme (cell 1) | 5 |
| TB1: New data indicator (cell 1) | 1 |
| TB1: Redundancy version (cell 1) | 2 |
| TB2 (if configured): Modulation and coding | 5 |
| scheme (cell 1) | |
| TB2 (if configured): New data indicator (cell 1) | 1 |
| TB2 (if configured): Redundancy version (cell 1) | 2 |
| HARQ process number (cell 1) | 4 |
| . . . | . . . |
| Frequency domain resource assignment (cell M) | 16 |
| Time domain resource assignment (cell M) | 4 |
| TB1: Modulation and coding scheme (cell M) | 5 |
| TB1: New data indicator (cell M) | 1 |
| TB1: Redundancy version (cell M) | 2 |
| TB2 (if configured): Modulation and coding | 5 |
| scheme (cell M) | |
| TB2 (if configured): New data indicator (cell M) | 1 |
| TB2 (if configured): Redundancy version (cell M) | 2 |
| HARQ process number (cell M) | 4 |
| CRC | 24 |

It should be understood that Table 7 is only for illustrative purposes, and should not be construed as limiting the embodiments of the present disclosure. For example, the second-stage DCI may only include cell-specific information fields. When some fields shown in Table 7 are set to common for all the co-scheduled cells (e.g., the same setting is shared among all the co-scheduled cells or the settings can be indicated via a joint indication), these fields can be removed from Table 7 and listed in, for example, Table 6.

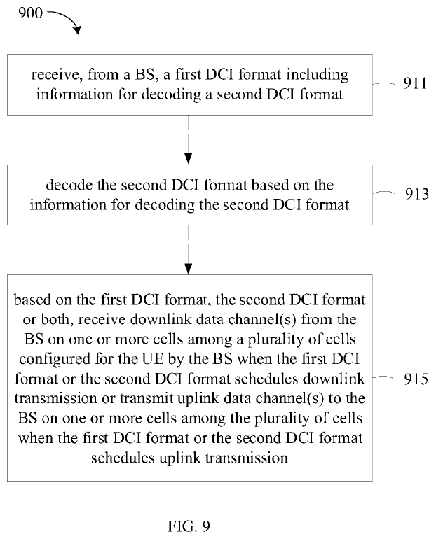

FIG. 9 illustrates a flow chart of exemplary procedure 900 for wireless communications in accordance with some embodiments of the present disclosure. Details described in all of the foregoing embodiments of the present disclosure are applicable for the embodiments shown in FIG. 9. In some examples, the procedure may be performed by a UE, for example, UE 101 in FIG. 1.

Referring to FIG. 9, in operation 911, the UE may receive, from a BS, a first DCI format including information for decoding a second DCI format. In operation 913, the UE may decode the second DCI format based on the information for decoding the second DCI format.

In operation 915, the UE may, based on the first DCI format, the second DCI format or both, receive downlink data channel(s) (e.g., PDSCH(s)) from the BS on one or more cells among a plurality of cells (e.g., cell set #1) configured for the UE by the BS when the first DCI format or the second DCI format schedules downlink transmission, or transmit uplink data channel(s) (e.g., PUSCH(s)) to the BS on one or more cells among the plurality of cells when the first DCI format or the second DCI format schedules uplink transmission.

In some embodiments of the present disclosure, the first and second DCI formats may be the first-stage and second-stage DCI formats as described above. For example, the first DCI format may be DCI #A1, DCI #B1, or DCI #C1, and the second DCI format may be DCI #A2, DCI #B2, or DCI #C2.

For example, in some embodiments of the present disclosure, the first DCI format may further include information for scheduling a first cell (e.g., cell #A or cell #B) of the one or more cells. In some embodiments of the present disclosure, receiving the downlink data channel(s) may include receiving a downlink data channel on the first cell based on the information for scheduling the first cell. In some embodiments of the present disclosure, transmitting the uplink data channel(s) may include transmitting an uplink data channel on the first cell based on the information for scheduling the first cell. For example, the first DCI format may be DCI #A1 or DCI #B1.

For example, in some embodiments of the present disclosure, the UE may determine a presence of the second DCI format based on the first DCI format. For example, the first DCI format may be DCI #A1 or DCI #B1, and the second DCI format may be DCI #A2 or DCI #B2.

In some embodiments of the present disclosure, decoding the second DCI format may include decoding the second DCI format when the second DCI format is determined to be present. In some embodiments of the present disclosure, receiving the downlink data channel(s) may include when the second DCI format is determined to be present, receiving a downlink data channel on a second cell of the one or more cells based on the second DCI format. In some embodiments of the present disclosure, wherein transmitting the uplink data channel(s) may include when the second DCI format is determined to be present, transmitting an uplink data channel on a second cell of the one or more cells based on the second DCI format.

In some embodiments of the present disclosure, the second DCI format is determined to be present when: the first DCI format indicates the one or more cells scheduled by the first and second DCI formats and the one or more cells include more than one cell; the first DCI format indicates the number of the one or more cells which is greater than one; the first DCI format indicates an applicable time domain offset between the first DCI format and the second DCI format; the first DCI format indicates an applicable resource for the second DCI format; an indicator in the first DCI format indicates that the second DCI format is present; the first DCI format indicates the one or more cells scheduled by the first and second DCI formats and a cell(s) scheduled by the first DCI format, the difference of which may include at least one cell; the first DCI format indicates a cell(s) scheduled by the second DCI format which may include at least one cell; or the first DCI format indicates the number of cells scheduled by the second DCI format which is greater than or equal to one.

Various methods may be employed for determining the cell where the second DCI format is received. For example, in some embodiments of the present disclosure, the second DCI format may be received on a predefined cell of the plurality of cells. In some embodiments of the present disclosure, the second DCI format may be received on a predefined cell of the one or more cells. In some embodiments of the present disclosure, the second DCI format may be received on a cell where the first DCI format is received. In some embodiments of the present disclosure, the first DCI format may indicate a cell where the second DCI format is transmitted.

In some embodiments of the present disclosure, the first DCI format may further include common scheduling information for the one or more cells and cell-specific information for scheduling at least one cell of the one or more cells, and the second DCI format may include cell-specific information for scheduling the remaining cell(s) of the one or more cells.

In some embodiments of the present disclosure, the second DCI format may include scheduling information for the one or more cells. For example, the first DCI format may not include any scheduling information for the co-scheduled cells.

In some embodiments of the present disclosure, the first DCI format may further include common scheduling information for the one or more cells and the second DCI format may include cell-specific information for scheduling the one or more cells.

In some embodiments of the present disclosure, the cell-specific information for scheduling a corresponding cell may indicate one or more of: a time domain resource assignment for the corresponding cell, a frequency domain resource assignment for the corresponding cell, an MCS for the corresponding cell, a HARQ process number for the corresponding cell, a new data indicator for the corresponding cell, and a redundancy version for the corresponding cell.

In some embodiments of the present disclosure, the common scheduling information for the one or more cells may indicate one or more of: VRB to PRB mapping information for the one or more cells, a PRB bundling size for the one or more cells, and PUCCH related information (such as DAI, TPC, PRI, HARQ timing indicator and etc.) for the one or more cells.

In some embodiments of the present disclosure, the information for decoding the second DCI format may indicate one or more of: a time domain offset between the first DCI format and the second DCI format, a resource for the second DCI format, the one or more cells among the plurality of cells, a payload size of the second DCI format, and a format of the second DCI format.

In some embodiments of the present disclosure, the UE may determine the number of PRBs carrying the second DCI format based on a payload size of the second DCI format and a coding rate for transmitting the second DCI format.

In some embodiments of the present disclosure, the UE may receive, from the BS, RRC signaling indicating a coding rate for transmitting the second DCI format. In some embodiments of the present disclosure, the first DCI format may indicate the coding rate.

It should be appreciated by persons skilled in the art that the sequence of the operations in exemplary procedure 900 may be changed and some of the operations in exemplary procedure 900 may be eliminated or modified, without departing from the spirit and scope of the disclosure.

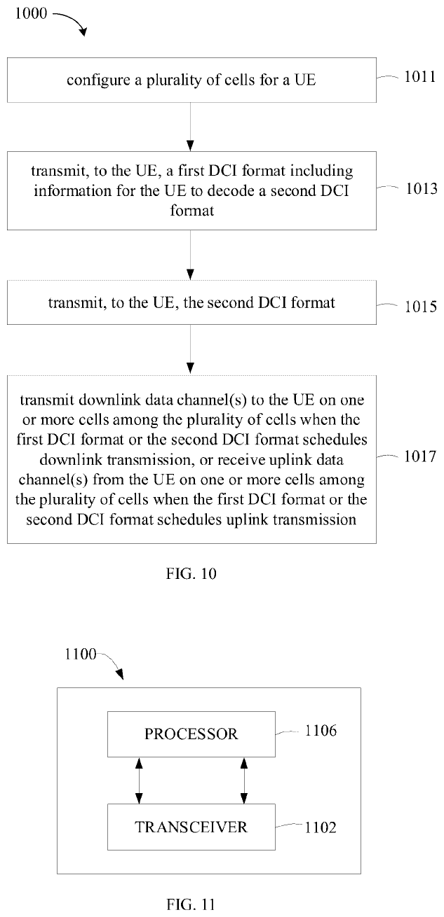

FIG. 10 illustrates a flow chart of exemplary procedure 1000 for wireless communications in accordance with some embodiments of the present disclosure. Details described in all of the foregoing embodiments of the present disclosure are applicable for the embodiments shown in FIG. 10. In some examples, the procedure may be performed by a BS, for example, BS 102 in FIG. 1.

Referring to FIG. 10, in operation 1011, a BS may configure a plurality of cells (e.g., cell set #1) for a UE. In operation 1013, the BS may transmit, to the UE, a first DCI format including information for the UE to decode a second DCI format. In operation 1015, the BS may transmit, to the UE, the second DCI format.

In operation 1017, the BS may transmit downlink data channel(s) (e.g., PDSCH(s)) to the UE on one or more cells among the plurality of cells when the first DCI format or the second DCI format schedules downlink transmission, or receive uplink data channel(s) (e.g., PUSCH(s)) from the UE on one or more cells among the plurality of cells when the first DCI format or the second DCI format schedules uplink transmission.

In some embodiments of the present disclosure, the first and second DCI formats may be the first-stage and second-stage DCI formats as described above. For example, the first DCI format may be DCI #A1, DCI #B1, or DCI #C1, and the second DCI format may be DCI #A2, DCI #B2, or DCI #C2.

For example, in some embodiments of the present disclosure, the first DCI format may further include information for scheduling a first cell (e.g., cell #A or cell #B) of the one or more cells. In some embodiments of the present disclosure, transmitting the downlink data channel(s) may include transmitting a downlink data channel on the first cell based on the information for scheduling the first cell. In some embodiments of the present disclosure, receiving the uplink data channel(s) may include receiving an uplink data channel on the first cell based on the information for scheduling the first cell. For example, the first DCI format may be DCI #A1 or DCI #B1.

For example, in some embodiments of the present disclosure, the BS may determine a presence of the second DCI format based on the first DCI format. For example, the first DCI format may be DCI #A1 or DCI #B1, and the second DCI format may be DCI #A2 or DCI #B2.

In some embodiments of the present disclosure, transmitting the second DCI format may include transmitting the second DCI format when the second DCI format is determined to be present. In some embodiments of the present disclosure, transmitting the downlink data channel(s) may include when the second DCI format is determined to be present, transmitting a downlink data channel on a second cell of the one or more cells based on the second DCI format. In some embodiments of the present disclosure, receiving the uplink data channel(s) may include when the second DCI format is determined to be present, receiving an uplink data channel on a second cell of the one or more cells based on the second DCI format.

In some embodiments of the present disclosure, the second DCI format is determined to be present when: the first DCI format indicates the one or more cells scheduled by the first and second DCI formats and the one or more cells include more than one cell; the first DCI format indicates the number of the one or more cells which is greater than one; the first DCI format indicates an applicable time domain offset between the first DCI format and the second DCI format; the first DCI format indicates an applicable resource for the second DCI format; an indicator in the first DCI format indicates that the second DCI format is present; the first DCI format indicates the one or more cells scheduled by the first and second DCI formats and a cell(s) scheduled by the first DCI format, the difference of which may include at least one cell; the first DCI format indicates a cell(s) scheduled by the second DCI format which may include at least one cell; or the first DCI format indicates the number of cells scheduled by the second DCI format which is greater than or equal to one.

Various methods may be employed for determining the cell where the second DCI format is transmitted. For example, in some embodiments of the present disclosure, the second DCI format may be transmitted on a predefined cell of the plurality of cells. In some embodiments of the present disclosure, the second DCI format may be transmitted on a predefined cell of the one or more cells. In some embodiments of the present disclosure, the second DCI format may be transmitted on a cell where the first DCI format is received. In some embodiments of the present disclosure, the first DCI format may indicate a cell where the second DCI format is transmitted.

In some embodiments of the present disclosure, the first DCI format may further include common scheduling information for the one or more cells and cell-specific information for scheduling at least one cell of the one or more cells, and the second DCI format may include cell-specific information for scheduling the remaining cell(s) of the one or more cells.

In some embodiments of the present disclosure, the second DCI format may include scheduling information for the one or more cells. For example, the first DCI format may not include any scheduling information for the co-scheduled cells.

In some embodiments of the present disclosure, the first DCI format may further include common scheduling information for the one or more cells and the second DCI format may include cell-specific information for scheduling the one or more cells.

In some embodiments of the present disclosure, the cell-specific information may indicate one or more of: a time domain resource assignment for a corresponding cell, a frequency domain resource assignment for the corresponding cell, an MCS for the corresponding cell, a HARQ process number for the corresponding cell, a new data indicator for the corresponding cell, and a redundancy version for the corresponding cell.

In some embodiments of the present disclosure, the common scheduling information the one or more cells may indicate one or more of: VRB to PRB mapping information for the one or more cells, a PRB bundling size for the one or more cells, and PUCCH related information (such as DAI, TPC, PRI, HARQ timing indicator and etc.) for the one or more cells.

In some embodiments of the present disclosure, the information for decoding the second DCI format may indicate one or more of: a time domain offset between the first DCI format and the second DCI format, a resource for the second DCI format, the one or more cells among the plurality of cells, a payload size of the second DCI format, and a format of the second DCI format.

In some embodiments of the present disclosure, the BS may determine the number of PRBs for transmitting the second DCI format based on a payload size of the second DCI format and a coding rate for transmitting the second DCI format.

In some embodiments of the present disclosure, the BS may transmit, to the UE, RRC signaling indicating a coding rate for transmitting the second DCI format. In some embodiments of the present disclosure, the first DCI format may indicate the coding rate.

It should be appreciated by persons skilled in the art that the sequence of the operations in exemplary procedure 1000 may be changed and some of the operations in exemplary procedure 1000 may be eliminated or modified, without departing from the spirit and scope of the disclosure.

FIG. 11 illustrates a block diagram of exemplary apparatus 1100 according to some embodiments of the present disclosure. As shown in FIG. 11, the apparatus 1100 may include at least one processor 1106 and at least one transceiver 1102 coupled to the processor 1106. The apparatus 1100 may be a UE or a BS.

Although in this figure, elements such as the at least one transceiver 1102 and processor 1106 are described in the singular, the plural is contemplated unless a limitation to the singular is explicitly stated. In some embodiments of the present disclosure, the transceiver 1102 may be divided into two devices, such as a receiving circuitry and a transmitting circuitry. In some embodiments of the present disclosure, the apparatus 1100 may further include an input device, a memory, and/or other components.

In some embodiments of the present disclosure, the apparatus 1100 may be a UE. The transceiver 1102 and the processor 1106 may interact with each other so as to perform the operations with respect to the UE described in FIGS. 1-10. In some embodiments of the present disclosure, the apparatus 1100 may be a BS. The transceiver 1102 and the processor 1106 may interact with each other so as to perform the operations with respect to the BS described in FIGS. 1-10.

In some embodiments of the present disclosure, the apparatus 1100 may further include at least one non-transitory computer-readable medium.

For example, in some embodiments of the present disclosure, the non-transitory computer-readable medium may have stored thereon computer-executable instructions to cause the processor 1106 to implement the method with respect to the UE as described above. For example, the computer-executable instructions, when executed, cause the processor 1106 interacting with transceiver 1102 to perform the operations with respect to the UE described in FIGS. 1-10.

In some embodiments of the present disclosure, the non-transitory computer-readable medium may have stored thereon computer-executable instructions to cause the processor 1106 to implement the method with respect to the BS as described above. For example, the computer-executable instructions, when executed, cause the processor 1106 interacting with transceiver 1102 to perform the operations with respect to the BS described in FIGS. 1-10.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE) for wireless communication, comprising:
at least one memory; and
at least one processor coupled with the at least one memory and configured to cause the UE to:
receive, from a base station (BS), a first downlink control information (DCI) format comprising information for decoding a second DCI format;
decode the second DCI format based on the information for decoding the second DCI format; and
based on the first DCI format, the second DCI format or both,
receive one or more downlink data channels from the BS on one or more cells among a plurality of cells configured for the UE by the BS when the first DCI format or the second DCI format schedules downlink transmission, or
transmit one or more uplink data channels to the BS on one or more cells among the plurality of cells when the first DCI format or the second DCI format schedules uplink transmission.

2. The UE of claim 1, wherein the first DCI format further comprises information for scheduling a first cell of the one or more cells; and
wherein receiving the one or more downlink data channels comprises receiving a downlink data channel on the first cell based on the information for scheduling the first cell, or
wherein transmitting the one or more uplink data channels comprises transmitting an uplink data channel on the first cell based on the information for scheduling the first cell.

3. The UE of claim 1, wherein the at least one processor is further configured to cause the UE to determine a presence of the second DCI format based on the first DCI format.

4. The UE of claim 3, wherein, to decode the second DCI format, the at least one processor is configured to cause the UE to: decode the second DCI format when the second DCI format is determined to be present; and
wherein, to receive the one or more downlink data channels, the at least one processor is configured to cause the UE to receive one or more downlink data channels on a second cell of the one or more cells based on the second DCI format when the second DCI format is determined to be present, or
wherein, to transmit the one or more uplink data channels, the at least one processor is configured to cause the UE to transmit one or more uplink data channels on a second cell of the one or more cells based on the second DCI format when the second DCI format is determined to be present.

5. The UE of claim 3, wherein the second DCI format is determined to be present when:
the first DCI format indicates the one or more cells scheduled by the first and second DCI formats and the one or more cells comprise more than one cell;
the first DCI format indicates a number of the one or more cells that is greater than one;
the first DCI format indicates an applicable time domain offset between the first DCI format and the second DCI format;
the first DCI format indicates an applicable resource for the second DCI format;
an indicator in the first DCI format indicates that the second DCI format is present;
the first DCI format indicates the one or more cells scheduled by the first and second DCI formats and one or more cell scheduled by the first DCI format, the difference of which comprises at least one cell;
the first DCI format indicates one or more cells cell scheduled by the second DCI format which comprises at least one cell; or
the first DCI format indicates the number of cells scheduled by the second DCI format which is greater than or equal to one.

6. The UE of claim 1, wherein the second DCI format is received on a predefined cell of the plurality of cells;
wherein the second DCI format is received on a predefined cell of the one or more cells;
wherein the second DCI format is received on a cell where the first DCI format is received; or
wherein the first DCI format indicates a cell where the second DCI format is transmitted.

7. The UE of claim 1, wherein the first DCI format further comprises common scheduling information for the one or more cells and cell-specific information for scheduling at least one cell of the one or more cells, and the second DCI format comprises cell-specific information for scheduling the remaining cells of the one or more cells.

8. The UE of claim 1, wherein the second DCI format comprises scheduling information for the one or more cells; or
wherein the first DCI format further comprises common scheduling information for the one or more cells and the second DCI format comprises cell-specific information for scheduling the one or more cells.

9. The UE of claim 1, wherein the information for decoding the second DCI format indicates one or more of:
a time domain offset between the first DCI format and the second DCI format,
a resource for the second DCI format,
the one or more cells among the plurality of cells, and
a payload size of the second DCI format, and
a format of the second DCI format.

10. The UE of claim 1, wherein the at least one processor is further configured to cause the UE to determine a number of physical resource blocks (PRBs) carrying the second DCI format based on a payload size of the second DCI format and a coding rate for transmitting the second DCI format.

11. The UE of claim 1, wherein the at least one processor is further configured to cause the UE to receive, from the BS, radio resource control (RRC) signaling indicating a coding rate for transmitting the second DCI format; or
wherein the first DCI format indicates the coding rate.

12. A base station (BS) for wireless communication, comprising:
at least one memory; and
at least one processor coupled with the at least one memory and configured to cause the BS to:
configure a plurality of cells for a user equipment (UE);
transmit, to the UE, a first downlink control information (DCI) format comprising information for the UE to decode a second DCI format;
transmit, to the UE, the second DCI format; and
transmit one or more downlink data channels to the UE on one or more cells among the plurality of cells when the first DCI format or the second DCI format schedules downlink transmission, or
receive one or more uplink data channels from the UE on one or more cells among the plurality of cells when the first DCI format or the second DCI format schedules uplink transmission.

13. The BS of claim 12, wherein, to transmit the second DCI format, the at least one processor is configured to cause the BS to transmit the second DCI format when the second DCI format is determined to be present; and
wherein, to transmit the one or more downlink data channels, the at least one processor is configured to cause the BS to, transmit a downlink data channel on a second cell of the one or more cells based on the second DCI format when the second DCI format is determined to be present, or
wherein, to receive the one or more uplink data channels, the at least one processor is configured to cause the BS to receive an uplink data channel on a second cell of the one or more cells based on the second DCI format when the second DCI format is determined to be present.

14. The BS of claim 12, wherein the at least one processor is further configured to cause the BS tp determine a presence of the second DCI format when:
the first DCI format indicates the one or more cells scheduled by the first and second DCI formats and the one or more cells comprise more than one cell;
the first DCI format indicates a number of the one or more cells that is greater than one;
the first DCI format indicates an applicable time domain offset between the first DCI format and the second DCI format;
the first DCI format indicates an applicable resource for the second DCI format;
an indicator in the first DCI format indicates that the second DCI format is present;
the first DCI format indicates the one or more cells scheduled by the first and second DCI formats and one or more cells scheduled by the first DCI format, the difference of which comprises at least one cell;
the first DCI format indicates one or more cells scheduled by the second DCI format which comprises at least one cell; or
the first DCI format indicates the number of cells scheduled by the second DCI format which is greater than or equal to one.

15. A method performed by a user equipment (UE), the method comprising:
receiving, from a base station (BS), a first downlink control information (DCI) format comprising information for decoding a second DCI format;
decoding the second DCI format based on the information for decoding the second DCI format; and
based on the first DCI format, the second DCI format or both,
receiving one or more downlink data channels from the BS on one or more cells among a plurality of cells configured for the UE by the BS when the first DCI format or the second DCI format schedules downlink transmission, or
transmitting one or more uplink data channels to the BS on one or more cells among the plurality of cells when the first DCI format or the second DCI format schedules uplink transmission.

16. The method of claim 15, wherein the first DCI format further comprises information for scheduling a first cell of the one or more cells; and
wherein receiving the one or more downlink data channels comprises receiving a downlink data channel on the first cell based on the information for scheduling the first cell, or
wherein transmitting the one or more uplink data channels comprises transmitting an uplink data channel on the first cell based on the information for scheduling the first cell.

17. The method of claim 15, further comprising determining a presence of the second DCI format based on the first DCI format.

18. The method of claim 15, wherein the second DCI format is received on a predefined cell of the plurality of cells;
wherein the second DCI format is received on a predefined cell of the one or more cells;
wherein the second DCI format is received on a cell where the first DCI format is received; or
wherein the first DCI format indicates a cell where the second DCI format is transmitted.

19. The method of claim 15, wherein the at least one processor is further configured to cause the UE to determine a number of physical resource blocks (PRBs) carrying the second DCI format based on a payload size of the second DCI format and a coding rate for transmitting the second DCI format.

20. A method performed by a base station (BS), the method comprising:
configuring a plurality of cells for a user equipment (UE);
transmitting, to the UE, a first downlink control information (DCI) format comprising information for the UE to decode a second DCI format;
transmitting, to the UE, the second DCI format; and
transmitting one or more downlink data channels to the UE on one or more cells among the plurality of cells when the first DCI format or the second DCI format schedules downlink transmission, or
receiving one or more uplink data channels from the UE on one or more cells among the plurality of cells when the first DCI format or the second DCI format schedules uplink transmission.
